(19) United States
(12) Patent Application Publication
(10) Pub. No.: US 2011/0164516 A1
(43) Pub. Date: Jul. 7, 2011

(54) METHOD AND SYSTEM FOR PROVIDING INFORMATION ACCESS, MULTIMEDIA CONTENT ACCESS, AND PHONE CONNECTIVITY

(76) Inventors: Venkat Kalkunte, Saratoga, CA (US); Phil Emmel, Marlow (GB)

(21) Appl. No.: 12/985,207

(22) Filed: Jan. 5, 2011

Related U.S. Application Data
(60) Provisional application No. 61/292,771, filed on Jan. 6, 2010.

(51) Int. Cl. H04L 12/26; H04W 4/00

(52) U.S. Cl. 370/252; 370/338

(57) ABSTRACT

The present invention is a method and system for providing information access, multimedia content access, and phone connectivity. The present invention includes a multimedia wireless network having a plurality of nodes and a plurality of media boxes. The nodes are mobile and can have a renewable energy unit. One or more of the nodes can be a gateway node to provide information, multimedia content, and phone connectivity from an external electronic device outside the multimedia wireless network to the multimedia wireless network. The media boxes can be all-in-one data access devices and can connect to the nodes to provide access to the information, the multimedia content, and phone connectivity to a variety of electronic devices. The nodes and the media boxes can maintain seamless access to a WLAN or a phone network. The nodes and the media boxes can also be connected in a mesh network.

### RELATED APPLICATIONS

This application claims the benefit of the U.S. Provisional Patent Application having Ser. No. 61/292,771, filed on Jan. 6, 2010 entitled “METHOD AND SYSTEM FOR PROVIDING INFORMATION ACCESS, MULTIMEDIA CONTENT ACCESS, AND PHONE CONNECTIVITY,” which is hereby incorporated by reference in its entirety.

### FIELD

The present invention relates to a method and system for providing information access, multimedia content access, and phone connectivity.

### RELATED ART

Access to multimedia content or phone networks conventionally requires large initial infrastructure investments, such as through laying cable to physically connect a city to its neighboring city and so on or building cellular towers. However, such solutions often require both the laying of cable and the addition of cellular towers. In cities where conversion to a substantially or completely wireless system is desirable, conventional cellular towers are ineffective due to the lack of signal penetration in certain buildings and the inability to handle large volumes of multimedia traffic.

While old buildings may be able to rely on cable connections as a backup system, the backup system may eventually be inoperative and thus the old buildings will face problems similar to new buildings where wireless systems are the only method of communication. For example, regardless of whether a large building is old, new, commercial, or residential, large buildings often include a large amount of concrete and metal, which inhibit signal penetration. As a result, occupants of the buildings are unable to receive reliable wireless connections in certain areas of the building and only get intermittent coverage.

Furthermore, current carrier infrastructure, such as the cellular towers, uses the licensed spectrum, which is limited. Thus, the carrier infrastructure is incapable of handling multi-media traffic from simultaneously bursting clients. Although the carrier networks today are well designed for voice traffic, with the advent of smart phones and high definition media consuming devices on the consumer front, consumer devices place a continuously increasing demand on carrier network. To alleviate such congestion, a system is necessary to automatically select the right method and network to use for certain high bandwidth operations provided the user is within the proximity of such an intelligent system or network. Thus conventional wireless systems are unable to provide reliable coverage and are also unable to support heavy demand.

Furthermore, existing communication systems require large infrastructure investments. The infrastructure investments described above are easily recouped in relatively dense populations, both because each city and surrounding neighborhoods are located relatively close in geographic proximity and the infrastructure costs are spread among the large population. However, in certain areas, infrastructure investments are difficult to recover, such as in rural areas. In those areas, it is cost-prohibitive to develop the infrastructure used to access the information since laying cable or building cellular towers can be very expensive where the cities and neighborhoods are far apart and where such large infrastructure costs are spread out over a relatively small population. Recent studies have shown, for example, that laying cable can cost as much or more than $500/ft.

Furthermore, solutions using conventional individual communication devices are undesirable due to requirements for exact positioning, unreliability (especially during severe weather), limited functionality, and the low data transmission rate. Support and maintenance of each of the conventional individual communications device can also be expensive since there will be many conventional individual communication devices, each with potential issues and different geographic locations.

Also, any such connections using the conventional infrastructure may have limited connectivity and may result in the rural population receiving access to the information in limited geographic locations. Furthermore, any such access provided by the connections may be interrupted if a user moves from one geographic location to another geographic location, rendering the connection impractical.

As a result of the cost-prohibitive nature of conventional infrastructure, relatively few rural communities receive the infrastructure necessary to access the ever changing information, the multimedia content, or the phone network. In addition, any such plans to provide the infrastructure may require a large amount of time period to implement due to the labor intensive requirements for such infrastructure. As a result, the rural communities become severely disadvantaged by the lack of access to the ever changing information, the multimedia content, or the phone network.

Thus, there is a need for a method and system for providing information access, multimedia content access, and phone connectivity that is capable of being implemented in areas where wireless solutions are desirable in a cost-effective manner, such as rural communities.

### SUMMARY

The present invention is a method and system for providing information access, multimedia content access, and phone connectivity in a cost-effective manner. The present invention can include, for example, a multimedia wireless network which can be implemented in areas where infrastructure implementation may be cost-prohibitive. The multimedia wireless network can have a plurality of nodes and a plurality of media boxes.

One or more of the nodes can be a gateway node which provides information, multimedia content, and phone connectivity from an external electronic device outside the multimedia wireless network to the multimedia wireless network using a gateway electronic device. The use of the gateway nodes and the gateway electronic device allows the multimedia wireless network 102 to concentrate access through the external electronic device.

The gateway nodes and the gateway electronic devices reduce the cost of each of the nodes and/or the media boxes, since the nodes and/or the media boxes will only be required to communicate over shorter distances. Furthermore, support and maintenance costs will be reduced since only a single gateway electronic device at a single geographic location needs to be supported and maintained when problems with access to the external electronic devices occur.

Within the multimedia wireless network, the nodes can be geographically spaced apart to ensure coverage of a desirable area. The nodes can also have renewable energy units which allow the nodes to harness energy from natural sources. This reduces maintenance costs and improves the range of the nodes since the nodes will not have to be connected to a power line nor will it have to have its battery recharged.

The media boxes can be located, for example, in a home and connected to the nodes to access the information, the multimedia content, and the phone connectivity. The media boxes can also provide access to the information, the multimedia content, and phone connectivity to a variety of electronic devices. Thus, the media box can be an all-in-one data access device. Therefore, instead of having multiple devices for cable, phone, and Internet access, a home would only need the media box to receive information access, multimedia access, and phone connectivity.

The nodes and the media boxes can maintain seamless access to a WLAN or a phone network. This allows an electronic device connected to the nodes or the media boxes to maintain its access to the WLAN or the phone network even when the electric device switches connection from one node or media box to another node or media box. The media boxes can also perform signal analysis to determine a phone connectivity quality for the electronic device. The media box can perform seamless handoff of the electronic device to a cellular tower when the phone connectivity quality becomes degraded. This allows the electronic device and any user of the electronic device to be mobile, without fear of losing his connection to the WLAN or the phone network.

The nodes and the media boxes can also be connected in a mesh network allowing for redundant access to the other nodes and media boxes. The redundant access improves data transmission time and also allows for an efficient back-up system to be in place. The nodes can also determine path delay information for the paths between the nodes and a node serving as a mesh block controller can analyze the path delay information to determine whether the paths should be altered. This can proactively allow the paths to be altered before the paths become unusable or cause problems.

The present invention can also extend a reach of a mesh network from an exterior of a building to an interior of the building through the placement of one or more nodes located at an exterior of the building and one or more nodes located at an interior of the building. The nodes located at the exterior of the building can be connected to the nodes located at the interior of the building through a switch.

The nodes can also proactively determine locations of electronic devices and multimedia content within the mesh network. This allows the nodes to quickly transmit data to the electronic devices and also allows for additional multimedia content to supplement the multimedia content supplied by an IP TV. In addition, the nodes can also reduce interruptions to video transmissions by predicting channel degradation, prioritizing video transmissions, and/or degrading video quality accordingly.

In one embodiment, the present invention is a wireless module including a memory, a processor connected to the memory, a session initiation protocol unit connected to the processor, and a transceiver connected to the processor, the transceiver configured to connect to a wireless local area network in multiple bands.

In another embodiment, the present invention is a wireless multimedia system including a first wireless module including a first processor, a first transceiver connected to the first processor and configured to connect to an electronic device and provide the electronic device access to a wireless local area network, and a first session initiation protocol unit connected to the first processor and configured to connect to a mobile phone and provide the mobile phone access to a phone network using a session initiated protocol. The present invention can also include a second wireless module including a second processor, a second transceiver connected to the second processor and configured to connect to the electronic device and seamlessly maintain access to the wireless local area network for the electronic device when the electronic device terminates connection with the first wireless module, and a second session initiation protocol unit configured to connect to the mobile phone and seamlessly maintain access to the phone network for the mobile phone when the mobile phone terminates connection with the first wireless module.

In yet another embodiment, the present invention is a method for providing multimedia content and phone connectivity including providing multimedia content to a first wireless module, providing an electronic device access to a wireless local area network using the first wireless module, providing the electronic device access to the wireless local area network using a second wireless module, seamlessly maintaining access to the wireless local area network for the electronic device when the electronic device terminates connection with the first wireless module, providing a mobile phone access to a phone network using the first wireless module, providing the mobile phone access to the phone network using the second wireless module, seamlessly maintaining access to the phone network for the mobile phone when the mobile phone terminates connection with the first wireless module.

In one embodiment, the present invention is a wireless module including a processor, a session initiation protocol unit connected to the process and configured to connect to a mobile phone and provide the mobile phone access to a phone network using a session initiated protocol, and a signal analysis unit connected to the processor and configured to analyze a phone connectivity quality for the phone network, the signal analysis unit performing a seamless handoff of the mobile phone to a cellular tower when the phone connectivity for the phone network is below a predetermined phone connectivity quality threshold.

In another embodiment, the present invention is a wireless network system including a first node located on an exterior of a building and connected to a network, a switch connected to the network through the first node, the switch located on an interior of the building, and a second node connected to the network through the switch, the second node located on the interior of the building.

In yet another embodiment, the present invention is a wireless module including a processor, a transceiver connected to the processor and configured to wirelessly connect to an electronic device, a memory connected to the processor and storing a routing table indicating a location of the electronic device, and a routing table update unit connected to the memory, the routing table update unit proactively determining a location of the electronic device and updating the routing table to indicate the location of the electronic device.

In one embodiment, the present invention is a wireless module including a processor, a transceiver connected to the processor and configured to wirelessly connect to other wireless modules, and a link analysis unit connected to the processor, the link analysis unit determining path delay information for paths between the wireless module and the other wireless modules.

In another embodiment, the present invention is a wireless module including a processor, a transceiver connected to the processor and configured to wirelessly connect to other wireless modules and receive path delay information for paths between the other wireless modules, and a route flow manager connected to the processor and analyzing the path delay information to determine whether paths between the other wireless modules should be altered.

In yet another embodiment, the present invention is a wireless module including a processor, a transceiver connected to the processor and configured to wirelessly connect to electronic devices and a network, and a media sharing prediction unit configured to analyze media traffic in the network and perform a media congestion reduction process.

In one embodiment, the present invention is a wireless module including a processor, a transceiver connected to the processor and configured to wirelessly connect to electronic devices and a network, and a channel state prediction unit configured to analyze interference in the network and perform a media congestion reduction process.

In another embodiment, the present invention is a wireless module including a processor, a transceiver connected to the processor and configured to wirelessly connect to a network, and a multimedia discovery unit configured to determine a location of multimedia content in the network.

### BRIEF DESCRIPTION OF THE DRAWINGS

The features, objects, and advantages of the present invention will become more apparent from the detailed description set forth below when taken in conjunction with the drawings, wherein:

FIG. 1 is diagram of an embodiment of the present invention;

FIG. 2 is a box diagram of a multimedia wireless network according to an embodiment of the present invention;

FIG. 3 is perspective view of a node according an embodiment of the present invention;

FIG. 4 is a box diagram of a node according to an embodiment of the present invention;

FIG. 5 is a box diagram of a media box according to an embodiment of the present invention;

FIG. 6 is a flow chart of a process according to an embodiment of the present invention;

FIG. 7 is box diagram of a media box according to an embodiment of the present invention;

FIG. 8 is a schematic diagram of a hand-off process according to an embodiment of the present invention;

FIG. 9 is a schematic diagram of a hand-off process according to an embodiment of the present invention;

FIG. 10 is a schematic diagram of a hand-off process according to an embodiment of the present invention;

FIG. 11 is a schematic diagram of a network configuration according to an embodiment of the present invention;

FIG. 12 is a box diagram of a node according to an embodiment of the present invention;

FIG. 13 is a schematic diagram of a network configuration according to an embodiment of the present invention;

FIG. 14 is a schematic diagram of a network configuration according to an embodiment of the present invention;

FIG. 15 is a box diagram of a node according to an embodiment of the present invention;

FIG. 16 is a box diagram of a node according to an embodiment of the present invention;

FIG. 17 is a schematic diagram of a network configuration according to an embodiment of the present invention;

FIG. 18 is a box diagram of a node according to an embodiment of the present invention;

FIG. 19 is a schematic diagram of a network configuration according to an embodiment of the present invention;

FIG. 20 is a schematic diagram of a network configuration according to an embodiment of the present invention;

FIG. 21 is a schematic diagram of a network configuration according to an embodiment of the present invention;

FIG. 22 is a box diagram of a node according to an embodiment of the present invention;

FIG. 23 is a schematic diagram of a network configuration according to an embodiment of the present invention;

FIG. 24 is a schematic diagram of a network configuration according to an embodiment of the present invention; and

FIG. 25 is a schematic diagram of a network configuration according to an embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

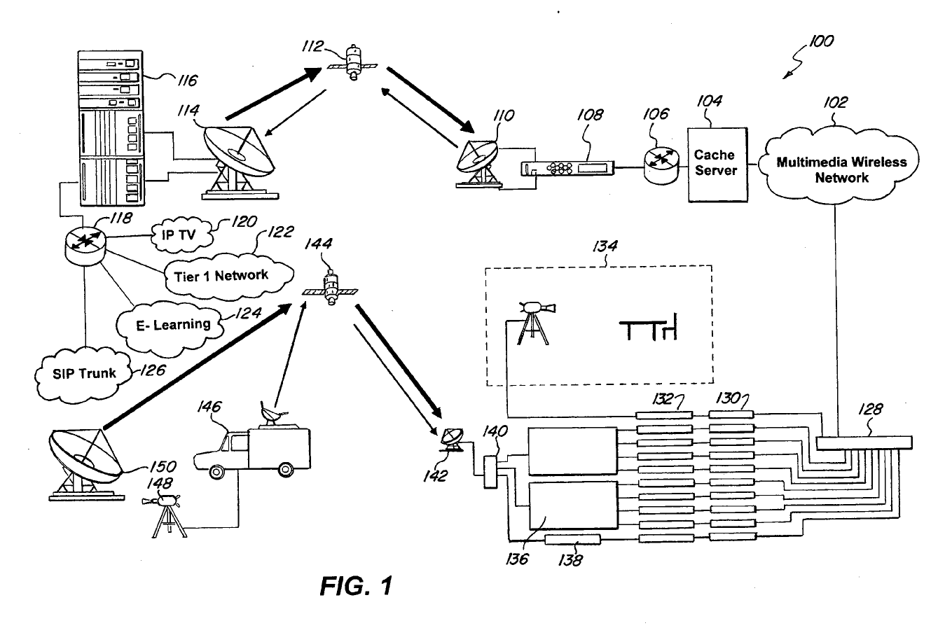

As seen in FIG. 1, in one embodiment, the present invention includes a system 100. The system 100 can allow for the transfer of a variety of data between electronic devices. The variety of data can be, for example, Internet content, multimedia content, data from phone connectivity, or any other type of data which can be transmitted from one electronic device to another electronic device. The multimedia content can include, for example broadcast data such audio content, video content, or audio/video content.

The system 100 can include, for example, a variety of electronic devices such as a multimedia wireless network 102, a cache server 104, a router 106, a modem 108, an antenna 110, a satellite 112, an antenna 114, a hub system 116, a router 118, a switch 128, compression units 130, video encoders 132, a television station 134, a satellite receiver 136, a satellite receiver 138, a combining unit 140, an antenna 142, a satellite 144, a broadcast unit 146, a camera 148, and/or an antenna 150. The antenna 110, the antenna 114, the antenna 142, and/or the antenna 150 can be, for example, any type of antenna capable of transmitting and/or receiving data from a satellite, such as an earth station antenna.

Data can be transmitted from each of the electronic devices in the system 100 to another electronic device in the system 100. In one embodiment, data can be transmitted between the multimedia wireless network 102 and the hub system 116. To transfer data between the multimedia wireless network 102 and the hub system 116, the data can be transmitted to the router 106, the modem 108, the antenna 110, the satellite 112, and the antenna 114. Since the hub system 116 is connected to the antenna 114, the hub system 116 can receive the data and transmit other data to the multimedia wireless network 102 using the same or similar path. Furthermore, since the multimedia wireless network 102 can communicate with the hub system 116, the hub system 116 can provide data to which the hub system 116 has access, to the multimedia wireless network 102. For example, in FIG. 1, the hub system 116 has access to such data as IP TV 120, Tier 1 Network 122, E-learning 124, and a session initiation protocol (SIP) Trunk 126. Thus, the multimedia wireless network 102 can have access to the IP TV 120, the Tier 1 Network 122, the E-learning 124, and the SIP Trunk 126. In one embodiment, the multimedia wireless network 102 can also disseminate information or publish to the IP TV 120, the Tier 1 Network 122, the E-learning 124, and/or the SIP Trunk 126.

The IP TV 120 can include, for example, multimedia content such as television shows, movies, or any other type of broadcast data which may be in an audio format, video format, and/or audio/video format. The Tier 1 Network 122 can include, for example, Internet content. The E-learning 124 can include, for example, programming related to distance learning. The SIP Trunk 126 can include, for example, data related to providing phone connectivity.

In one embodiment, the hub system 116 can provide access control regarding which data the multimedia wireless network 102 can access from the hub system 116 and/or which data the multimedia wireless network 102 disseminates. For example, if it is desirable for the multimedia wireless network 102 to have access to the IP TV 120, the Tier 1 Network 22, and the SIP Trunk 126, but not the E-learning 124, the hub system 116 can prevent the multimedia wireless network 102 from accessing the E-learning 124. Similarly, the hub system 116 can also prevent the multimedia wireless network 102 from disseminating data to the E-learning 124. Access to the data available in the hub system 116 or disseminating data to the hub system 116 can also be provided on a fee or a subscription basis. Thus, to access the E-learning 124 or publish to the E-learning 124, the users of the multimedia wireless network 102 may have to purchase the rights to access or publish to the E-learning 124.

Likewise, even if the IP TV 120 is generally accessible, certain portions may be accessible only through fees or subscriptions for a period of time and/or to select users. Thus, if a new movie is released, it may only be accessible for a fee or subscription for the first three months after the new movie is released and potentially to only select users. The users can be, for example, heads of studios, movie theatres, or other select entities which should be granted access to the movie. Subsequently, the fee or subscription requirement may be reduced or eliminated and/or an amount of users which can access the movie increased.

Alternatively, or in addition to the fee or subscription requirement, the hub system 116 could provide access to the data in exchange for inserting content into the data. Such content could be, for example, advertisements, or other promotional material. Thus, if the IP TV 120 includes a television show, advertisements could be periodically inserted into the television show. Likewise, audio advertisements may be inserted periodically into a phone conversation for the SIP Trunk 126, particularly where there is a delay in connecting one user to another user or if one user is placed on hold.

In another embodiment, the hub system 116 can filter the data which the multimedia wireless network 102 can access from the hub system 116. The hub system 116 can also filter data which the multimedia wireless network 102 transmits to the hub system 116. In yet another embodiment, the hub system 116 can insert additional data or proprietary data to the data which the multimedia wireless network 102 can access from the hub system 116 or the data received from the multimedia wireless network 102. The additional or proprietary data could be, for example, advertisements, promotional material, notification information, emergency information, additional programming relevant to the geographic location of the multimedia wireless network 102, or any other type of additional or proprietary data which should be transmitted to the multimedia wireless network 102.

In another embodiment, data can be transmitted to and from the television station 134 using the video encoders 132, the compression units 130, and/or the switch 128. The television station 134 can be, for example, a local television station which is local to a geographic location of the multimedia wireless network 102. However, the television station 134 can also be a local station which is local to another geographic location. Since the multimedia wireless network 102 is connected to the hub system 116, users with access to the hub system 116 can also have access to data from the television station 134 using the hub system 116 and the multimedia wireless network 102. In addition, the television station 134 can also have access to data from the hub system 116 through the multimedia wireless network 102.

In yet another embodiment, data can be transmitted to and from the camera 148 and/or the antenna 150. The camera 148 can provide data such as multimedia content in a non-stationary manner since the camera does not need to be constantly in a fixed location, such as a building. Thus, the camera 148 can cover many locations. To provide the multimedia content to the multimedia wireless network 102, the camera 148 can transmit the video through the broadcast unit 146, the satellite 144, the antenna 142, the combining unit 140, the satellite receiver 138, the satellite receiver 136, the video encoders 132, the compression units 130, and/or the switch 128. In addition, the hub system 116 and/or the television station 134 could also have access to the multimedia content from the camera 148.

Furthermore, the antenna 150 can provide data such as the Direct-to-Home (DTH) television (TV) to the multimedia wireless network 102 using the satellite 144, the antenna 142, the combining unit 140, the satellite receiver 138, the satellite receiver 136, the video encoders 132, the compression units 130, and/or the switch 128. The television station 134 and/or the hub system 116 could also have access to the DTH TV.

The multimedia wireless network 102 can provide access to the variety of data in areas where Internet connectivity, multimedia content connectivity, and/or phone connectivity can be difficult to implement. Such areas can include, for example, rural areas where it may be cost-prohibitive to physically lay cables to provide access to the variety of data, implement cellular towers, implement telephone poles, and/or implement a large amount of satellite dishes. Limited access to the variety of data can also occur, for example, in high rise buildings or dense structures with much concrete and/or metal.

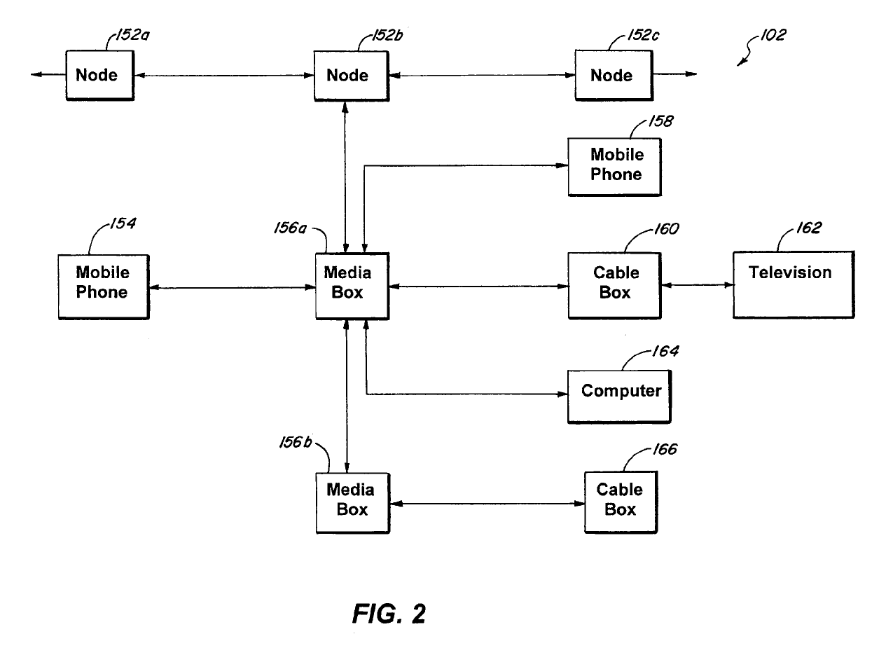

The multimedia wireless network 102 can be seen, for example, in FIG. 1 and FIG. 2. The multimedia wireless network 102 can receive data from a gateway electronic device. The gateway electronic device is able to funnel access for the multimedia wireless network 102 to data from electronic devices, such as the hub system 116. The gateway electronic device is also able to funnel access for the electronic device to data from the multimedia wireless network 102. In FIG. 1, the gateway electronic device can include, for example, the antenna 110, the modem 108, the router 106, and/or the cache sever 104.

The multimedia wireless network 102 can include wireless modules such as nodes 152 and media boxes 156. The nodes 152 can include, for example, nodes 152a, 152b, and 152c. The media boxes 156 can include, for example, media boxes 156a and 156b. The use of the nodes 152 and the media boxes 156 reduces or obviates the necessity for conventional infrastructure to be implemented. For example, the use of the nodes 152 and the media boxes 156 reduces an amount of cable that needs to be laid into the ground, and/or a number of cellular towers that need to be erected. The use of the nodes 152 and the media boxes 156 can reduce infrastructure costs from $500/ft for laying cable to less than $1/ft. In some instances the infrastructure costs can be less than $0.50/ft and even less than $0.25/ft.

In FIG. 2, the media box 156a is connected to the node 152b. The nodes 152 can provide, for example, multimedia content, Internet connectivity, and/or phone connectivity to the media boxes 156. The media box 156b, a mobile phone 154, a mobile phone 158, a cable box 160, and a computer 164 are connected to the media box 156a. The television 162 is connected to the cable box 160. The cable box 166 is connected to the media box 156b.

The media boxes 156 are all-in-one data access devices, and can be located, for example, in each individual home. The media boxes 156, using the nodes 152, provide multimedia content, Internet connectivity, and/or phone connectivity to the mobile phone 154, the mobile phone 158, the cable box 160, the computer 164, and/or the cable box 166. The television 162 receives access to the data provided by the multimedia wireless network 102 through the cable box 160. However, in one embodiment, the cable box 160 is optional and the television 162 connects directly to either the media boxes 156 or the nodes 152.

The nodes 152 and the media boxes 156 can be connected, for example, in a mesh network. The mesh network allows for redundant access to the other nodes and media boxes within the multimedia wireless network 102. The redundant access improves data transmission time and also allows for an efficient back-up system to be in place. The nodes 152 and the media boxes 156 can transmit data to each other, for example, using a one plus one (1+1) ring protection mode in the mesh network.

The nodes 152 can transmit wirelessly for a distance. In one embodiment, the nodes 152 can be strategically placed to balance wireless coverage for a geographic area with cost considerations. For example, if the nodes 152 can each transmit for a distance of 10 miles, the nodes 152a and 152b can each be placed 20 miles from each other. Since, the nodes 152 can transmit for 10 miles, a media box 156 located exactly in the middle between the node 152a and the node 152b will be able to access both the node 152a and the node 152b. Such access is possible because the media box 156 is 10 miles from the node 152a and 10 miles from the node 152b. Media boxes 156 located elsewhere will have access to either the node 152a or the node 152b, provided they are within a 10 mile radius of either the node 152a or the node 152b.

In another embodiment, the nodes 152 can be strategically placed to increase the wireless coverage for the geographic area and provide, for example, redundant coverage. Thus, if the nodes 152 can transmit for a distance of 10 miles, then the node 152a and the node 152b can be placed, for example 16 miles apart. In such a case, if the media box 156 is exactly between the node 152a and the node 152b, the media box 156 will be 8 miles from each of the nodes 152a and 152b.

One or more of the nodes 152 can also be located to function as gateway nodes. Gateway nodes can provide the link between the multimedia wireless network 102 and any external electronic devices outside the multimedia wireless network 102 using the gateway electronic device, but without the use of other nodes 152. The external electronic devices can be, for example, the hub system 116, the television station 134, the camera 148, and/or the antenna 150. For example, if the node 152a was connected to the antenna 110 either wirelessly, or electrically through a wired connected, then the node 152a can be a gateway node since the node 152a would be able to access the hub system 116 without the use of any other nodes 152 in the multimedia wireless network 102.

In one embodiment, access to the external electronic device is achieved only through the use of the gateway nodes and the gateway electronic device. This can reduce the cost of each electronic device within the multimedia wireless network 102 since the nodes 156 and/or the media box 152 within the multimedia wireless network 102 do not need to have the capability to contact the hub system 116. Instead, the nodes 156 and/or the media box 152 need only be able to contact with each other. All data transmission/reception is funneled to the gateway electronic device. The gateway electronic device would be sufficiently capable of connecting to the hub system 116. Furthermore, any issues with data transmission/reception to the multimedia wireless network 102 can be localized to the gateway electronic device and it would be unnecessary to determine if there are issues with one or more of the nodes 152 and/or the media box 156 in attempting to connect to the hub system 116.

Whereas it would be cost-prohibitive to station a dedicated user to each of the conventional individual communication devices, a dedicated user can be stationed near the gateway electronic device to ensure that the gateway electronic device operates properly. This can reduce a downtime of the multimedia wireless network 102 and also reduce a cost of maintenance of the multimedia wireless network 102.

Furthermore, since the nodes 152 and/or the media boxes 156 only need to communicate with each other and/or the gateway electronic device, such communications occur at a relatively short distance. The short distance increase the reliability of such communications and also improves the data transmission rate. Furthermore, the short distance reduces any effect any severe weather will have on the communications.

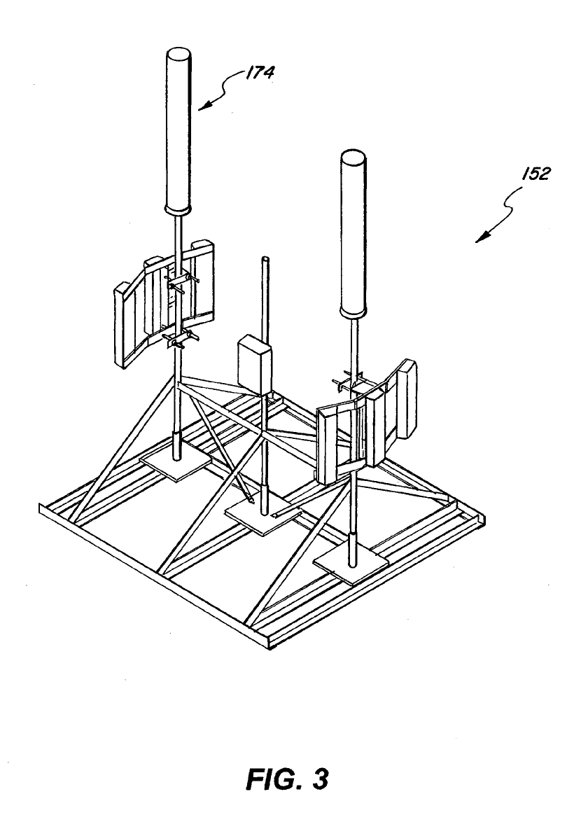

FIG. 3 is a perspective view of the node 152. As can be seen in FIG. 3, the node 152 includes an antenna 174. The node 152 also appears rugged and is easily adaptable to a variety of geographic terrain. Furthermore, the node 152 is relatively mobile and can be placed at a variety of geographic locations. The mobility of the nodes 152 also allows a problematic node to be easily replaced by a replacement node should any problems arise with one of the nodes 152. Instead of requiring the problematic node to be fixed immediately, which can take an extended period of time, particularly if a diagnosis of the problem is also required, the problematic node can easily be replaced. The problematic node can be repaired at a convenient location and time, reducing the cost of maintenance and service. In the meantime, there is little downtime within the multimedia wireless network 102 since the transmission/reception load of the problematic node is taken up by the replacement node. This allows the multimedia wireless network 102 to remain functional even when issues occur with one or more of the nodes 152.

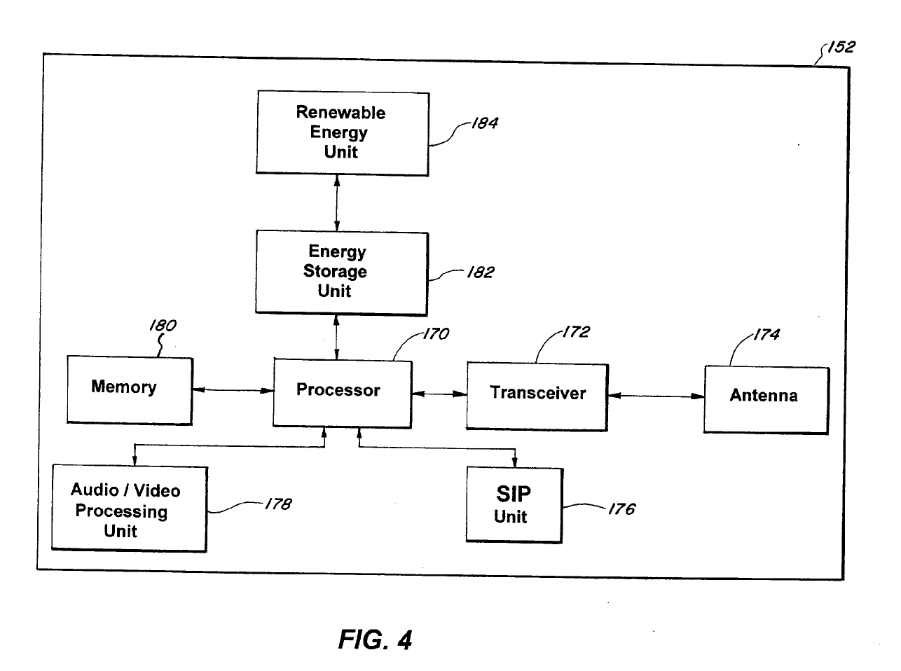

FIG. 4 is a box diagram of the node 152. The node 152, in addition to the antenna 174, includes a processor 170, a transceiver 172, a memory 180, an energy storage unit 182, a renewable energy unit 184, an audio/video processing unit 178, and a SIP unit 176. The processor 170 is connected to the transceiver 172, the SIP unit 176, the audio/video processing unit 178, the memory 180, and the energy storage unit 182. The processor 170 can process a variety of data, such as Internet content, multimedia content, data from phone connectivity, or any other type of data which can be transmitted from one electronic device to another electronic device. The processor 170 can also control the transceiver 172, the SIP unit 176, the audio/video processing unit 178, the memory 180, and the energy storage unit 182.

The transceiver 172 and the antenna 174 can be used to transmit and/or receive data and connect to a wireless local area network (WLAN) and/or provide phone connectivity to mobile and/or cordless phones. The WLAN can be, for example, an 802.11 WLAN, and more specifically an 802.11n multiple-input multiple-output (MIMO) WLAN. The transceiver 172 and the antenna 174 can operate in multiple bands. For example, the transceiver 172 and the antenna 174 can operate in one or more of a 900 MHz band, 2.4 GHz, 4.9 GHz, and/or 5 GHz band. Thus, the node 152a can communicate with the node 152b in a WLAN in a 900 MHz band, while the node 152a can communicate with the node 152c in a WLAN in a 4.9 GHz band. In addition, the nodes 152 can communicate with the media boxes 156 in one or more of the 900 MHz band, 2.4 GHz, 4.9 GHz, and/or 5 GHz band.

The bands can be selected to improve reliability, data transmission rate, and/or reduce interference. This allows the multimedia wireless network 102 as a whole to be more efficient since bands which are occupied do not impede communications within the WLAN or phone connectivity. Although 4 bands are described above, any number of bands at any frequency may also be used. In one embodiment, the transceiver 172 and/or the antenna 174 are bi-directional, or omni-directional. This reduces any requirement for exact positioning of the transceiver 172 and/or the antenna 174.

The transceiver 172, the antenna 174, and/or the processor 170 can also be used to seamlessly provide access to the WLAN. For example, if a media box 156a was mobile and originally connected to the node 152a, it can travel from a location near the node 152a to a location near the node 152b. When the media box 156a approaches the location near the node 152b, the node 152b can seamlessly maintain access to the WLAN for the media box 156a. The media box 156a will therefore not lose connectivity to the WLAN. In one embodiment, an electronic device which connects to the WLAN using the nodes 152 does not need to re-authenticate when switching nodes with which it accesses the WLAN.

For example, when the media box 156a switches connection from the node 152a to the node 152b, the media box 156a will not need to re-authenticate with the node 152b. Thus, the user of an electronic device connecting to the WLAN can now move around without fear of losing access to the WLAN or having the user's access to the WLAN be interrupted. This can be beneficial, for example, if the user is using a computer to access the WLAN for Voice over Internet Protocol (VoIP). Instead of losing the VoIP connection due to a loss of access to the WLAN during a transition from one node to another node, the nodes 152 of the present invention allows the user to maintain his connection to the VoIP by seamlessly maintaining the user's access to the WLAN. The seamless maintenance of access to the WLAN can also be beneficial, for example, where live or real-time transmission of data is critical such as for live audio transmissions, live video transmissions, and/or live updates.

The energy storage unit 182 is connected to the processor 170 and the renewable energy unit 184. The energy storage unit 182 can be, for example, a battery or any other type of storage unit which can store energy sufficient to power the node 152 or provide reserve power for the node 152. The energy storage unit 182 can be, for example, a primary energy storage unit, and/or a backup energy storage unit. As a backup energy storage unit, the energy storage unit 182 can be, for example, a redundant backup energy storage unit. The energy storage unit 182 can also be, for example, a rechargeable battery. In one embodiment, the energy storage unit 182 is a lithium-ion battery.

The renewable energy unit 184 is connected to the energy storage unit 182 and can be, for example, a windmill, a solar panel, a heat capture unit, or any other type of unit which can convert natural energy into power suitable to provide energy to the energy storage unit 182. In one embodiment, the renewable energy unit 184 can provide trickle charging to the energy storage unit 182. In another embodiment, the renewable energy unit 184 can provide trickle charging to the energy storage unit 182 when the energy storage unit 182 is the primary energy storage unit, and/or the backup energy storage unit. The renewable energy unit 184 improves the geographic location with which the nodes 152 can be placed since the nodes 152 will have a reduced dependence on being near a power line. In addition, the renewable energy unit 184 reduces an operational cost of the nodes 152 since the renewable energy unit 184 can supply sufficient power to operate the nodes 152.

The audio/video processing unit 178 is connected to the processor 170. The audio/video processing unit 178 can be used to process broadcast data. The processed broadcast data can be in a format suitable for use by an electronic device connected to the nodes 152.

The SIP unit 176 is connected to the processor 170 and can be used in conjunction with the processor 170, the transceiver 172, and/or the antenna 174, to provide phone connectivity for an electronic device connected to the nodes 152, such as a cordless or mobile phone. The electronic device can also be connected to the nodes 152 through one of the media boxes 156. The SIP unit 176 can provide phone connectivity, for example, to a phone network, such as the SIP Trunk 126 of the hub system 116.

The SIP unit 176, the processor 170, the transceiver 172, and/or the antenna 174, can also maintain seamless access to the phone network for the electronic device. For example, if a mobile phone was connected to the node 152a, but a user of the mobile phone was moving towards the node 152b, the node 152b would seamlessly maintain access to the phone network for the mobile phone. Thus, the user will not lose connectivity to the phone network, or have access the to phone network interrupted. In one embodiment, the mobile phone which connects to the phone network using the nodes 152 does not need to re-authentic when switching nodes with which it accesses the WLAN.

For example, when the mobile phone switches connection from the node 152a to the node 152b, the mobile phone will not need to re-authenticate with the node 152b. Thus, the user of the mobile phone connecting to the phone network can move around without fear of losing access to the phone network. This can be beneficial, for example, if the user is in the middle of a conversation while using the mobile phone.

In FIG. 2, the media boxes 156 is an all-in-one data access device and can facilitate data transfer between the nodes 152 and electronic devices, and/or between the electronic devices. As previously disclosed, the media boxes 156 can be connected to a variety of electronic devices, such as a mobile phone 154, a mobile phone 158, a cable box 160, a television 162, a computer 164, and/or a cable box 166. The media boxes 156 can provide multimedia content, data, and/or phone connectivity to the mobile phone 154, the mobile phone 158, the cable box 160, the television 162, the computer 164, and/or the cable box 166.

For example, using the media boxes 156, the electronic devices can have access to standard definition television (SDTV), high definition television (HDTV), video on demand, karaoke on demand, SIP telephony, three-dimensional (3D) games, SIP telephony, and other value added services. The SDTV can be provided, for example at greater than 700 Kb/s, while the HDTV can be provided, for example, at greater than 2 Mb/s.

The media boxes 156 can be connected through a wired connection or wirelessly to each of the electronic devices. Furthermore, additional electronic devices can be connected to the media boxes 156 which may benefit from transmitting and/or receiving a variety of data, such as Internet content, multimedia content, data from phone connectivity, or any other type of data which can be transmitted from one electronic device to another electronic device. The media boxes 156 can thus facilitate the data transfer between the nodes 152 and the electronic devices, and/or between the electronic devices.

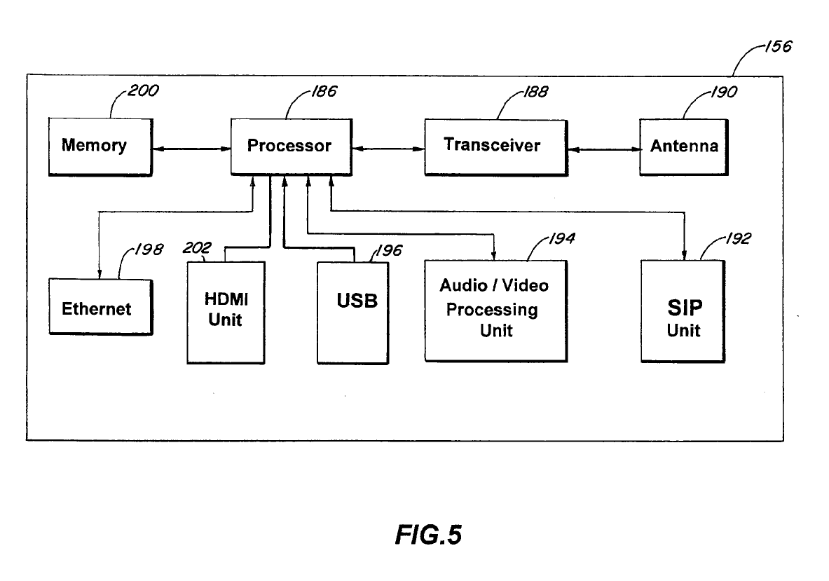

As seen in FIG. 5, the media box 156 can include, for example, a processor 186, a transceiver 188, an antenna 190, a SIP unit 192, an audio/video processing unit 194, a universal serial bus (USB) 196, an Ethernet unit 198, and/or a memory 200. The processor 186 can be any type of processor capable of processing a variety of data and content including Internet content, multimedia content, data from the phone connectivity, or any other type of data which can be transmitted from one electronic device to another electronic device. In one embodiment, the processor 186 can utilize the Linux Operating System.

The transceiver 188 and the antenna 190 are connected to the processor 186. The transceiver 188 and the antenna 190 can operate in multiple bands. For example, the transceiver 188 and the antenna 190 can operate in one or more of a 900 MHz band, 2.4 GHz, 4.9 GHz, and/or 5 GHz band. Thus, the media box 156a can communicate with the media box 156b in a WLAN in a 900 MHz band, while the media box 156a can communicate with the computer 164 in a WLAN in a 4.9 GHz band. In addition, the media boxes 156 can communicate with the nodes 152 in one or more of the 900 MHz band, 2.4 GHz, 4.9 GHz, and/or 5 GHz band.

The bands can be selected to improve reliability, data transmission rate, and/or reduce interference. This allows the multimedia wireless network 102 as a whole to be more efficient since bands which are occupied do not impede communications within the WLAN or phone connectivity. Although 4 bands are described above, any number of bands at any frequency may also be used. In one embodiment, the transceiver 188 and/or the antenna 192 are bi-directional, or omni-directional. This reduces any requirement for exact positioning of the transceiver 188 and/or the antenna 192.

The memory 200 is connected to the processor 186 and can be used to store data for the processor 186 or any other component in the media box 156. The Ethernet 198 is connected to the processor 186 and can be used to provide Ethernet access for an electronic device external to the media box 156. For example, the computer 164 in FIG. 2 can connect to the media box 156a using the Ethernet 198. Using the Ethernet 198, the electronic device connected to the media box 156a can have access to the variety of data or other electronic devices that is connectable or is accessible by the media box 156a.

The High-Definition Multimedia Interface (HDMI) unit 202 is connected to the processor 186. The HDMI unit 202 can provide multimedia content to an electronic device, such as the cable box 160 and/or the television 162. In one embodiment, the multimedia content is high definition multimedia content. The HDMI unit 202 allows the cable box 160 and/or the television 162 to receiving the multimedia content. The multimedia content can be, for example, from the hub system 116, the television station 134, the camera 148, and/or the antenna 150. Although an HDMI unit is shown in FIG. 5, other video connections can be used, such as a RCA connector.

The audio/video processing unit 194 is connected to the processor 186 and can be used to process the multimedia content. The processed multimedia content can be in a format usable by an electronic device connected to the media box 156. The USB unit 196 is connected to the processor 186 and can provide an interface for an electronic device, such as the cable box 160, the mobile phone 158, the computer 164, and/or the television 162, to connect to the media box 156. In one embodiment, the audio/video processing unit 194 can include a BCM7405.

The SIP unit 192 is connected to the processor 186 and can be used in conjunction with the processor 186, the transceiver 188, and/or the antenna 190, to provide phone connectivity for an electronic device connected to the media box 156, such as a cordless or mobile phone. The SIP unit 192 can provide phone connectivity, for example, to a phone network, such as the SIP Trunk 126 of the hub system 116.

The SIP unit 192, the processor 186, the transceiver 188, and/or the antenna 190, can also maintain seamless access to the phone network for the electronic device. For example, if a mobile phone was connected to the media box 156a, but a user of the mobile phone was moving towards the media box 156b, the media box 156b would seamlessly maintain access to the phone network for the mobile phone. Thus, the user will not lose connectivity to the phone network, or have access the to phone network interrupted. In one embodiment, the mobile phone which connects to the phone network using the media boxes 156 does not need to re-authentic when switching media boxes with which it accesses the WLAN.

For example, when the mobile phone switches connection from the media box 156a to the media box 156b, the mobile phone will not need to re-authenticate with the media box 156b. Thus, the user of the mobile phone connecting to the phone network can move around without fear of losing access to the phone network. Again, this can be beneficial, for example, if the user is in the middle of a conversation while using the mobile phone and does not wish to have the conversation interrupted.

In one embodiment, the multimedia wireless network 102 can also implement access control to determine which electronic devices can connect to the multimedia wireless network 102 at what data connection speed. For example, the multimedia wireless network 102 can implement Quality of Service (QoS) control. Access to the multimedia wireless network 102 can be differentiated based on each user profile. Each user profile can include, for example, bandwidth allotment, latency control, and/or network status control. Furthermore, the QoS can be used to perform traffic management.

The multimedia wireless network 102 can also be in an open architecture system platform using modular concepts. The multimedia wireless network 102 can also provide IPv6 support, have multiple service set identifiers (SSIDs), provide wireless backhaul, provide multicast support, support for latency-sensitive IP Mobile Applications, support multiple security options for authentication and encryption, provide complex IP Mobile networking support and fast roaming backhaul, and/or provide optimized radio drivers.

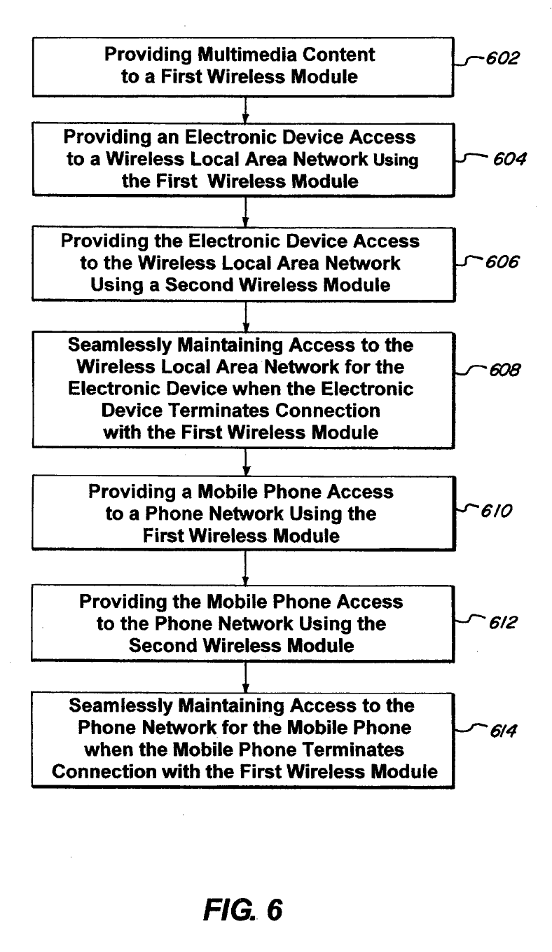

In one embodiment, the present invention is a process, as disclosed in FIG. 6. In Step S602, multimedia content is provided to a first wireless module. For example, multimedia content can be provided to the node 152a and/or the media box 156a. In Step S604, an electronic device is provided access to a WLAN using the first wireless module. For example, a computer is provided access to the WLAN using the node 152a and/or the media box 156a. In Step S606, the electronic device is provided access to a WLAN using a second wireless module. For example, the computer is provided access to the WLAN using the node 152b and/or the media box 156b.

In Step S608, access to the WLAN for the electronic device is seamlessly maintained when the electronic device terminates connection with the first wireless module. For example, access to the WLAN for the computer is seamlessly maintained when the computer terminates connection with the node 152a and/or the media box 156a. The seamless maintenance of the WLAN access can be provided, for example, by the node 152b and/or the media box 156b.

In Step S610, a mobile phone is provided access to a phone network using the first wireless module. For example, a mobile phone is provided access to the phone network using the node 152a and/or the media box 156a. In Step S612, the mobile phone is provided access to the phone network using the second wireless module. For example, the mobile phone is provided access to the phone network using the node 152b and/or the media box 156b.

In Step S614, the access to the phone network is seamlessly maintained for the mobile phone when the mobile phone terminates connection with the first wireless module. For example, the access to the phone network is seamlessly maintained for the mobile phone when the mobile phone terminates connection with the node 152a and/or the media box 152a. The seamless maintenance of the phone network access can be provided, for example, by the node 152b and/or the media box 156b.

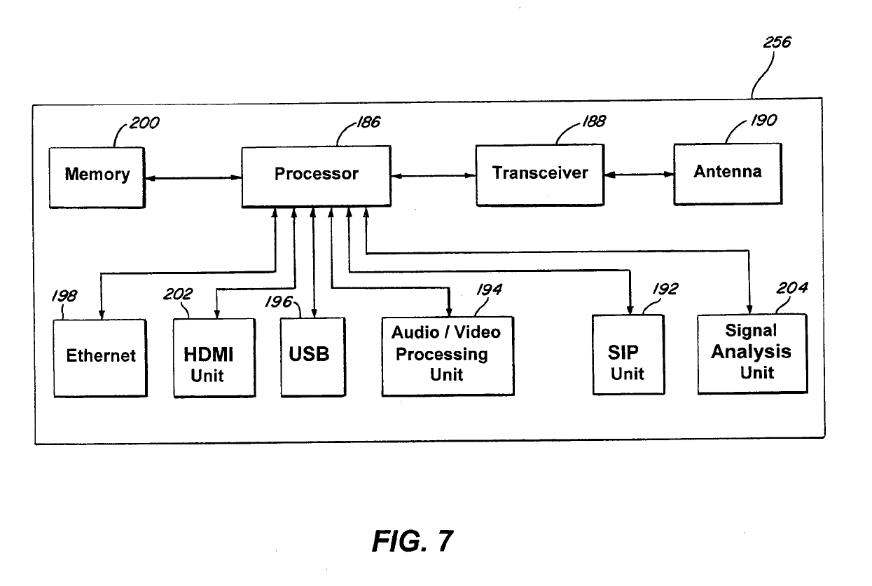

In one embodiment, the present invention can perform seamless handoffs, such as seamless voice handoffs for VoIP, cellular, SIP, any other types of connections, and/or any combinations of the above. For example, the present invention can switch from a VoIP connection using SIP to a cellular connection using the cellular tower. The cellular connection can be, for example, a CDMA, GSM, or any other type of cellular connection. In the present invention, the media box can perform signal analysis to determine when an electronic device connected to the media box should perform handoff and switch, for example, to another phone service provider device during phone connectivity. The electronic device can be, for example, a mobile phone, and the phone service provider device can be, for example, a cellular tower. The present invention can utilize, for example, a media box 256 as shown in FIG. 7. The media box 256 is similar to the media box 156 except that the media box 256 further includes a signal analysis unit 204 connected to the processor 186. The signal analysis unit 204 can perform, analysis, such as signal analysis to determine whether the electronic devices connected to the media box 256 should be connected to another phone service provider device. If the signal analysis unit 204 determines that the electronic device should connect to another phone service provider device, the signal analysis unit 204 can facilitate the hand-off process.

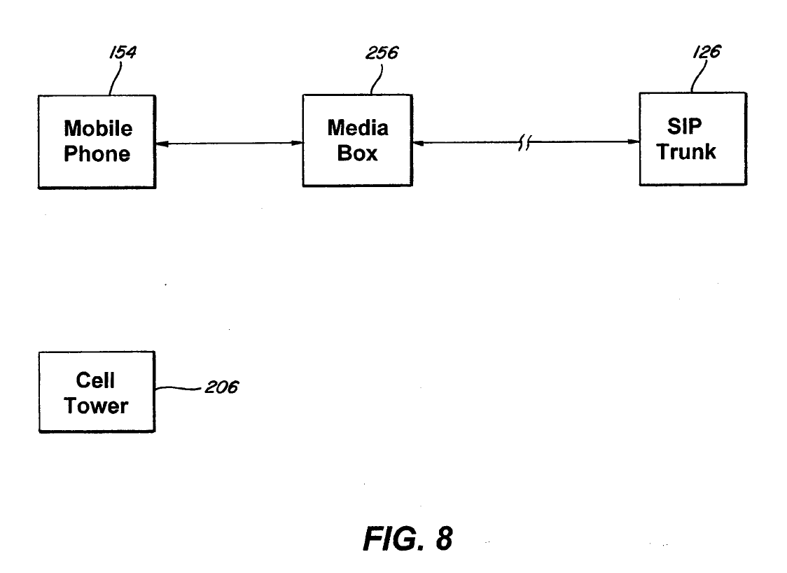

As seen in FIG. 8, a mobile phone 154 is connected to a SIP trunk 126 through a media box 256. The mobile phone 154, the media box 256, and/or the SIP trunk 126 can be located within the system 100 or outside the system 100. The mobile phone 154 has phone connectivity using SIP through the media box 256. The signal analysis unit 204 in the media box 256 can periodically monitor the quality of phone connectivity for the mobile phone 154 to determine whether the phone connectivity has degraded below a predetermined phone connectivity quality threshold, or could potentially become degraded below a predetermined phone connectivity quality threshold prior to a predetermined time threshold. The predetermined phone connectivity quality threshold can be selected to be threshold such that voice or data communication is still sufficiently clear and/or still has an acceptable error rate.

The signal analysis unit 204 can determine the quality of the phone connectivity for example, by monitoring the connection between the mobile phone 154 and the media box 256, and/or the media box 256 and the SIP trunk 126. In monitoring the phone connectivity, the signal analysis unit 204 can also determine whether potential inferences may degrade the phone connectivity for the mobile phone 154. For example, the signal analysis unit 204 can determine whether an interference source, such as another electronic device is moving towards the mobile phone 154 and/or the media box 256 which could eventually degrade the phone connectivity of the mobile phone 154. The signal analysis unit 204 can also determine whether there are too many devices connected to the media box 256 which could degrade the phone connectivity of the mobile phone 154.

The media box 256 can employ, for example, the latest digital signal processing algorithms such as Maximal Ratio Combining (MRC), and Maximum Likelihood Detection (MLD) and Adaptive Channel Estimation and Equalization (ACE) to ensure robust reception of packets. Furthermore, based on a receiver antenna sensitivity of the device connected to the media box 256, and/or clients, the media box 256 is able to adjust beam forming patterns to improve the quality of the ongoing voice connection or phone connectivity and to schedule handoff. This can allow, for example, the mobile phone 154 to deliver greater wireless throughput and range with assistance from mesh infrastructure that includes media box 256.

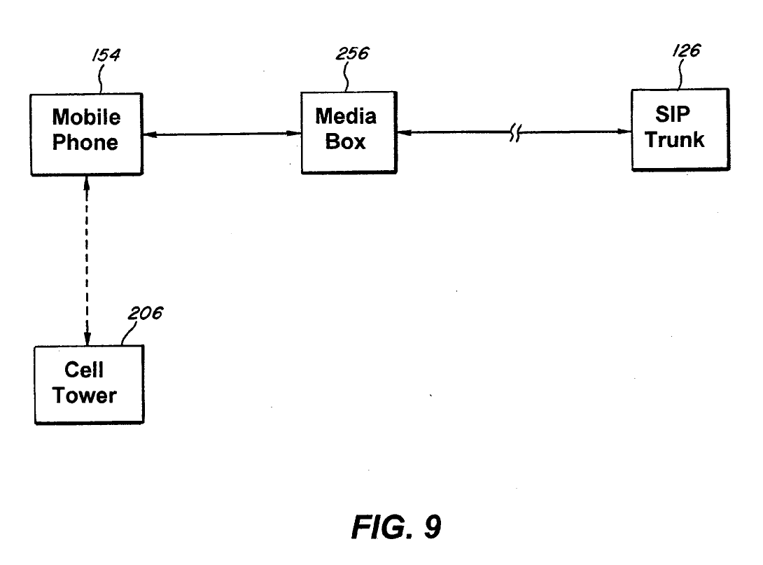

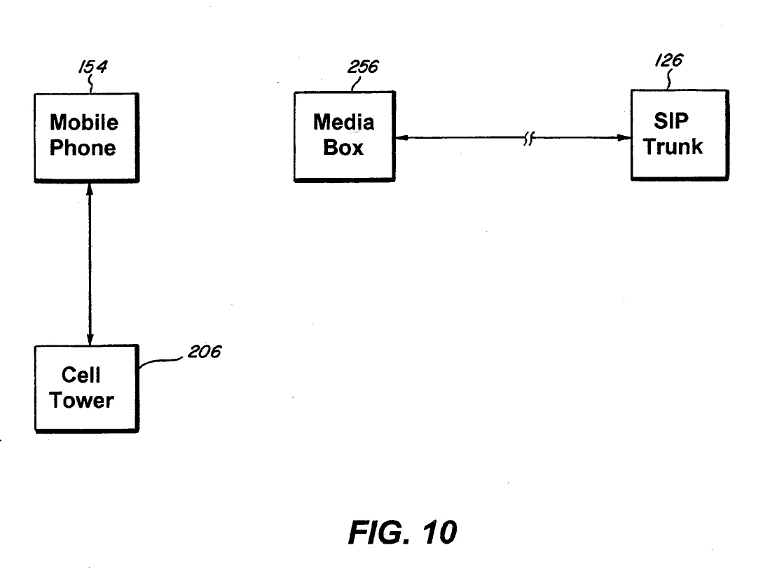

When the signal analysis unit 204 determines that the phone connectivity is degraded below the predetermined phone connectivity quality threshold, or could potentially become degraded beyond a predetermined phone connectivity quality threshold, the signal analysis unit 204 and/or the processor 186 could indicate to the mobile phone 154 that a hand-off should occur. Once the mobile phone 154 receives the indication that a hand-off should occur, the mobile phone 154 can commence communication with a cell tower 206 as seen in FIG. 9. While the mobile phone 154 is communicating with the cell tower 206 to establish a connection to the cell tower 206, the mobile phone 154 can still maintain phone connectivity through the media box 256. Once the mobile phone 154 has established phone connectivity to the cell tower 206, the mobile phone 154 disconnects from the media box 256 and seamlessly maintains phone connectivity as seen in FIG. 10. In one embodiment, the user will not lose phone connection during the handoff process, even though the user is switching from a VoIP connection to a cellular connection.

Thus, the present invention proactively maintains the quality of the phone connection by seamlessly switching the phone connection from the media box to the cellular tower. Instead of waiting until the phone quality degrades below the predetermined phone connectivity quality threshold, the present invention proactively prevents the phone connection from degrading below the predetermined phone connectivity quality threshold. This may be beneficial, for example, during important phone conversations where communication quality is important.

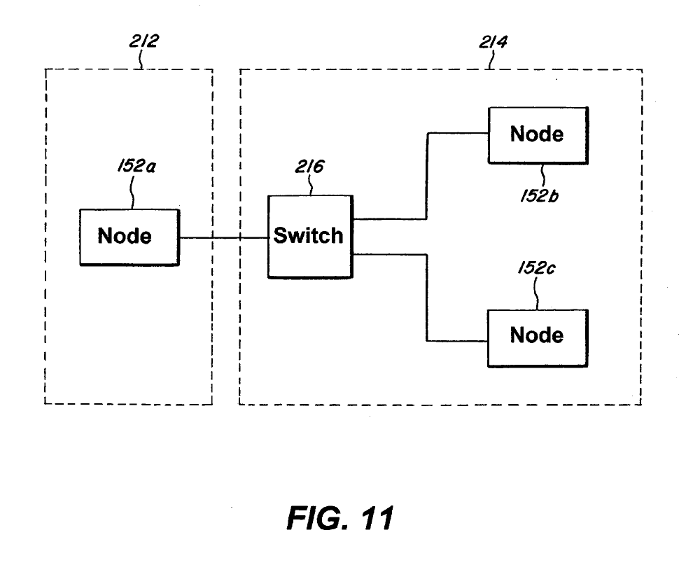

In one embodiment the present invention can extend network connectivity from a position exterior to a building to a position interior to a building without significant signal loss or attenuation. As seen in FIG. 11, a network 212 can be connected to a network 214. The network 212 can provide, for example, information access, multimedia content access, and/or phone connectivity. The network 212 can be located, for example, in a position exterior to a building, while the network 214 can be located, for example, in a position interior to a building. The network 214 can extend the network connectivity of the network 212 to the interior of the building and provide, for example, information access, multimedia content access, and/or phone connectivity to the interior of the building.

As seen in FIG. 11, the network 212 includes a node 152a while the network 214 includes a switch 216, a node 152b, and/or a node 152c. The network 214 is connected to the network 212 through the connection between the switch 216 and the node 152a. The node 152a can be located, for example, at a position exterior to the building, such as on top of the building. The switch 216 can be located, for example, at a position interior to the building. The node 152b and the node 152c can also be located at the position interior to the building. Thus, network connectivity can be extended to the interior of the building and the interior of the building can have for example, information access, multimedia content access, and/or phone connectivity. This can be beneficial, for example, where it is difficult for signal penetration into buildings, such as building with a large amount of concrete or steel, even when the node 152a is located just outside the building. With the present invention, the network connectivity inside the building can be improved over conventional network systems and higher data rate and accuracy can be achieved.

The node 152b and the node 152c can be strategically located in various locations in the building to maximize network connectivity and/or reduce signal loss. In one embodiment, the node 152b is located on a first floor while the node 152c is located on a second floor. This can also improve the network connectivity within the building since each floor may be separated by large amounts of concrete and/or steel which may interfere with the signals of the nodes 152.

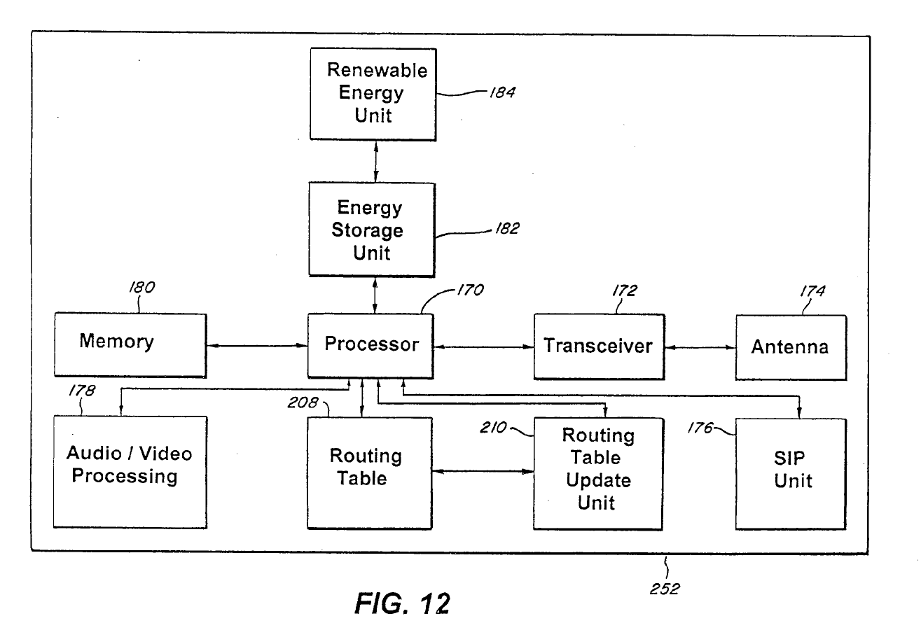

In another embodiment, the present invention can proactively determine locations of electronic devices when the electronic devices change locations. This can reduce transmission delays, for example, when the electronic devices change locations. This may be beneficial, for example, during video transmission and the electronic device changes locations and/or is mobile. In one embodiment, the present invention can use a node 252 as seen in FIG. 12. The node 252 is similar to the node 152, except that the node 252 further includes a routing table 208 and a routing table update unit 210.

The routing table 208 is connected to the processor 170 and/or the routing table update unit 210. The routing table can store the locations of various routes to various electronic devices. For example, the routing table can store the locations of various routes for electronic devices electronically connected to the node 252, a network which the node 252 belongs to, a network surrounding the network which the node 252 belongs to, and/or the system 100.

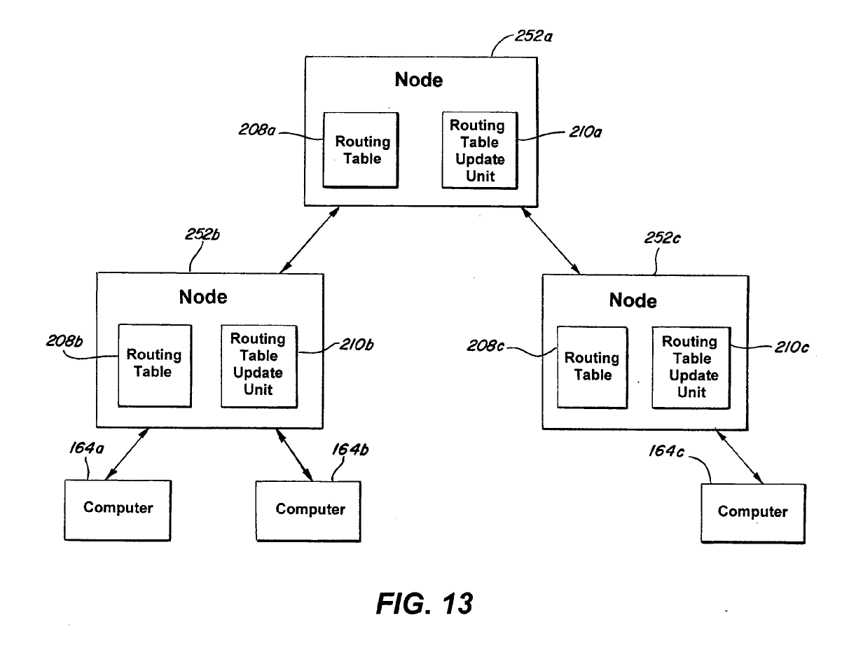

For example, nodes 252a, 252b, and 252c can comprise a network such as a mesh network within the system 100 or outside the system 100 as shown in FIG. 13. The node 252a can be, for example, a dynamic host configuration protocol (“DHCP”) server for the network. As seen in FIG. 13, the routing tables 208a, 208b, and 208c, and the routing table update units 210a, 210b, and 210c for each of the nodes 252a, 252b, and 252c are shown for illustrative purposes while other components of the nodes 252a, 252b, and 252c are not shown. The node 252a can be, for example, a mesh block controller. The node 252a can help disseminate information or facilitate communication between all of the nodes 252 in a mesh network of the mesh block controller. The nodes 252b and 252c can be connected to the node 252a. Furthermore, computers 164a and 164b can be connected to the node 252b while the computer 164c can be connected to the node 252c.

The routing table 208b for each of the nodes 252a, 252b, and 252c can determine the location of the computers 164a, 164b, and 164c and/or the path to the computers 164a, 164b, and 164c. For example, for the computer 164a to communicate with the computer 164c, the routing table 208b in the node 252b can indicate that the computer 164c is connected to the node 252c and that the path to the computer 164c should include the node 252b, then the node 252a, and then the node 252c. Furthermore, the routing table 208b for the node 252b can also include the locations of the computers 164a and 164b. Thus, for example, if the computer 164a wanted to communicate with the computer 164b, the routing table 208b in the node 252b would indicate that both the computers 164a and 164b were connected to the node 252b and that the path to the computer 164b would include the node 252b. Likewise the routing tables 208a and 208c can also contain information regarding the computers 164a, 164b, and/or 164c.

The routing table update units 210a, 210b, and/or 210c can also update the routing tables 208a, 208b, and/or 208c. The routing table update units 210a, 210b, and/or 210c can, for example update the routing tables 208a, 208b, and/or 208c in a periodic, proactive, continuous, case-by-case manner, and/or any other manner deemed appropriate. In one embodiment, the routing table update units 210a, 210b, and/or 210c can, for example, update the routing tables 208a, 208b, and/or 208c when the computers 164a, 164b, and/or 164c change locations. The computers 164a, 164b, and/or 164c can change locations such as by disconnecting from one node 252 and/or connecting to a different node 252.

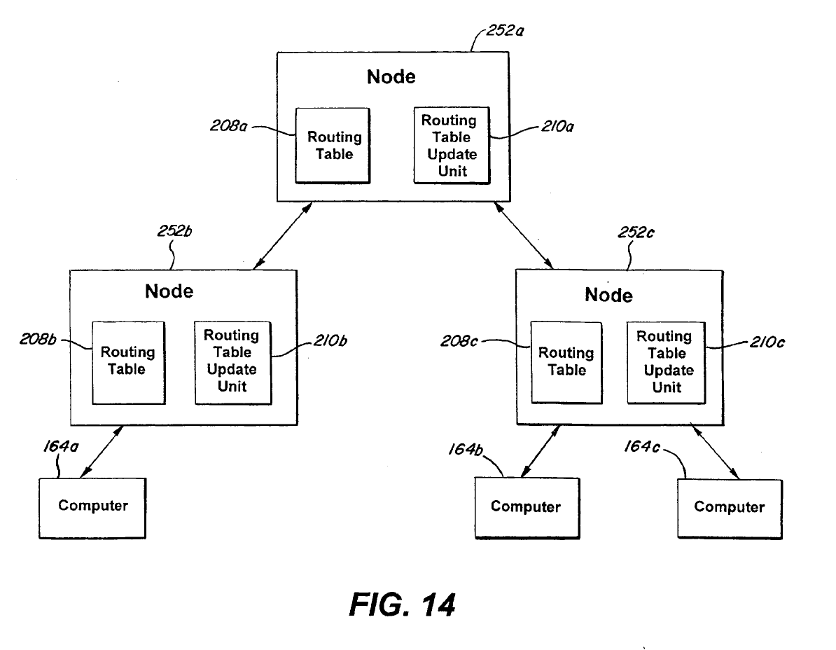

For example, in FIG. 14, the computer 164b disconnected from the node 252b and connected to the node 252c. In one embodiment, the node 252b can detect the disconnection of the computer 164b from the node 252b, and the routing table update unit 210b can propagate the information to the routing table update units 210a and/or 210c. The routing table update units 210a, 210b, and/or 210c can update the routing tables 208a, 208b, and 208c to reflect the disconnection of the computer 164b from the node 252b.

In one embodiment, the node 252c can detect the connection of the computer 164b to the node 252c, and the routing table update unit 210c can propagate the information to the routing table update units 210a and/or 210b. The routing table update units 210a, 210b, and/or 210c can update the routing tables 208a, 208b, and 208c to reflect the connection of the computer 164b to the node 252c. Thus, if the computer 164a wanted to communicate with the computer 164b, the routing tables 208a, 208b, and/or 208c would indicate that the computer 164b is connected to the node 252c and that the path to the computer 164b would include the node 252b, the node 252a, and the node 252c.

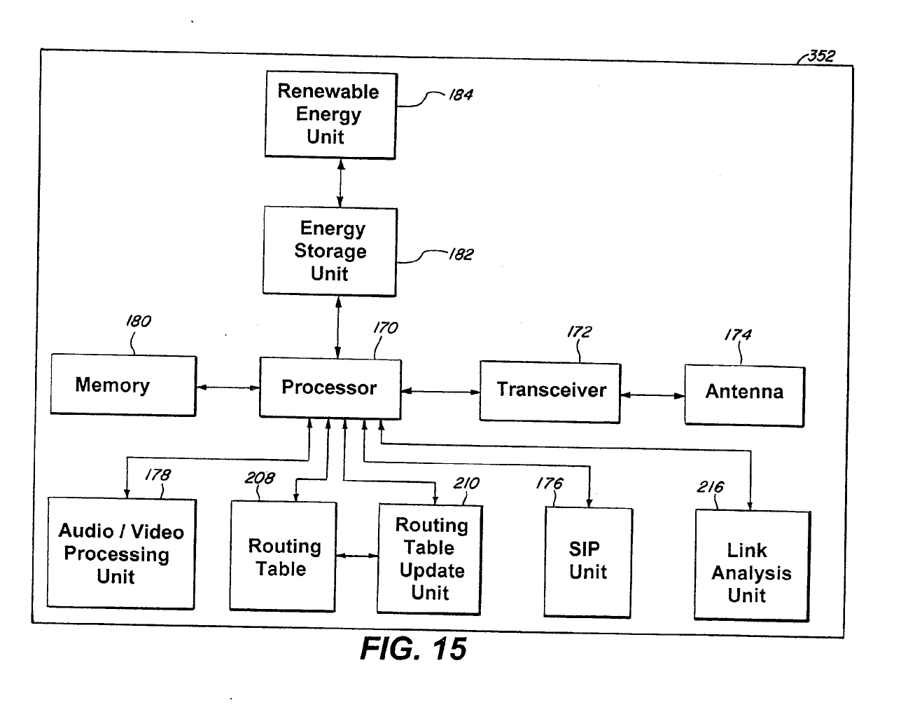

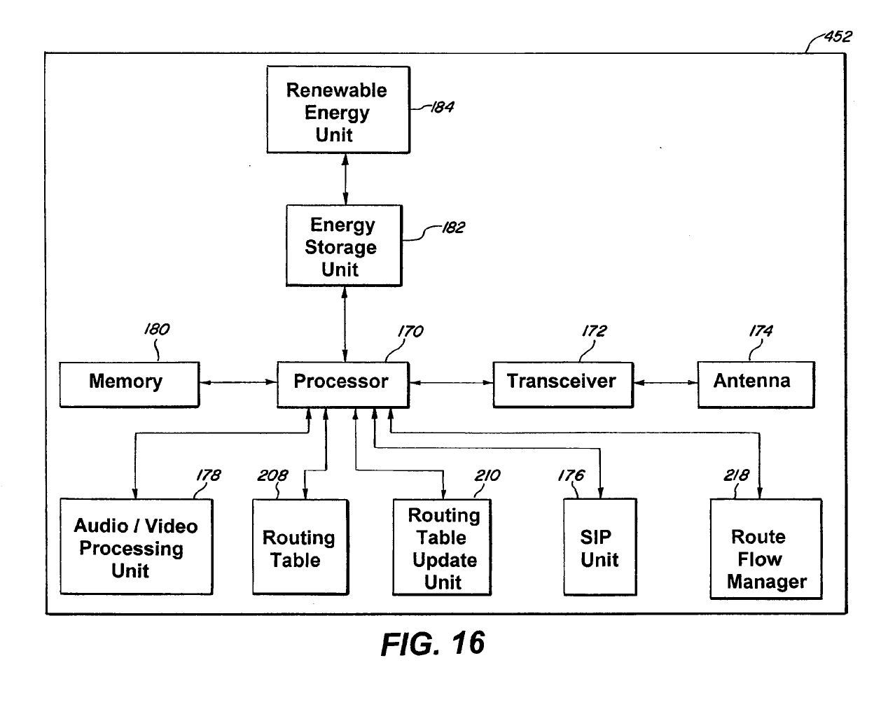

In another embodiment, the present invention can proactively route wireless traffic to reduce congestion and/or signal degradation. The present invention can utilize for example, a node 352 as shown in FIG. 15 and a node 452 as shown in FIG. 16. In FIG. 15, the node 352 is similar to the node 252 except that the node 352 further includes a link analysis unit 216. The link analysis unit 216 can sample and analyze the path delay information for the path between the node 352 and another node within a network of the node 352. The path delay information can include the time required to traverse the path between the two nodes and/or the signal-to-noise ratio between the two nodes. The network can be, for example, a mesh network.

In FIG. 16, the node 452 can be, for example, a mesh block controller. The node 452 is similar to the node 252 except it includes a route flow manager 218. The router flow manager can receive path delay information from the link analysis unit 216 in the node 352 and instruct the node 252 to update the information in the routing table 208 based on the path delay information from the link analysis unit 216. For example, if the link analysis unit 216 for the node 352 indicated that the path to another node had a high SNR, the route flow manager 218 could instruct the routing table update unit 210 to switch to another path to reach the another node.

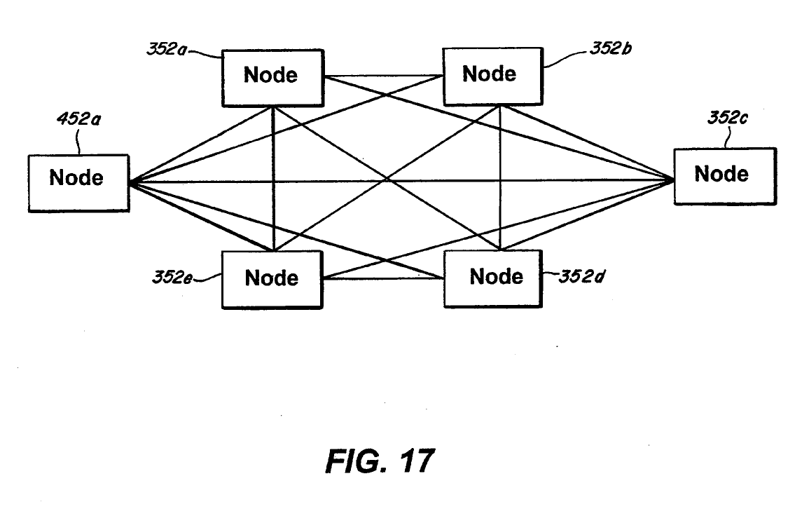

FIG. 17 illustrates the node 352 and the node 452 in operation. As seen in FIG. 17, the node 452a is the mesh block controller, while the nodes 352a, 352b, 352c, 352d, and 352e belong to the mesh network of the node 452a. The link analysis units 216 for the nodes 352a, 352b, 352c, 352d, and 352e can sample and send path delay information including signal-to-noise ratios (“SNR”) for each of the paths in the routing table 208. For example, the routing table 208 for the node 352a could indicate that the path from the node 352a to the node 352b is a direction connection, while the path from the node 352a to the node 352c should be from the node 352a to the node 352d to the node 352c. The link analysis unit 216 for the node 352a can send path delay information including SNR for the path from the node 352a to the node 352b, and for the path from the node 352a to the node 352d to the node 352e. The SNR information can be acquired, for example, using 802.11 protocol.

The route flow manager 218 can analyze the path delay information from the link analysis unit 216 for the paths to and from the node 352a and determine whether any of the paths should be altered. For example, if the route flow manager 218 determines that the path between the node 352a and the node 352b has a SNR below a predetermined SNR threshold, or will have a signal to nose ratio below the predetermined SNR threshold, then the route flow manager 218 can determine a modified path for the node 352a to the node 352b, such as the path from the node 352e to the node 352d to the node 352b. The modified path for the for the node 352a to the node 352b can then be transmitted to the routing table update unit 210 for the node 352a so that it may update its routing table 208.

The route flow manager 218 could also analyze the path between the node 352a and the node 352c, which is the path from the node 352a to the node 352d to the node 352c, and determine that the path from the node 352a to the node 352c has a SNR above the predetermined SNR threshold. Thus, the route flow manager 218 could send no signal to the routing table update unit 210 for the node 352a, or the route flow manager 218 could indicate to the routing table update unit 210 that the path between the node 352a and the node 352c is acceptable.

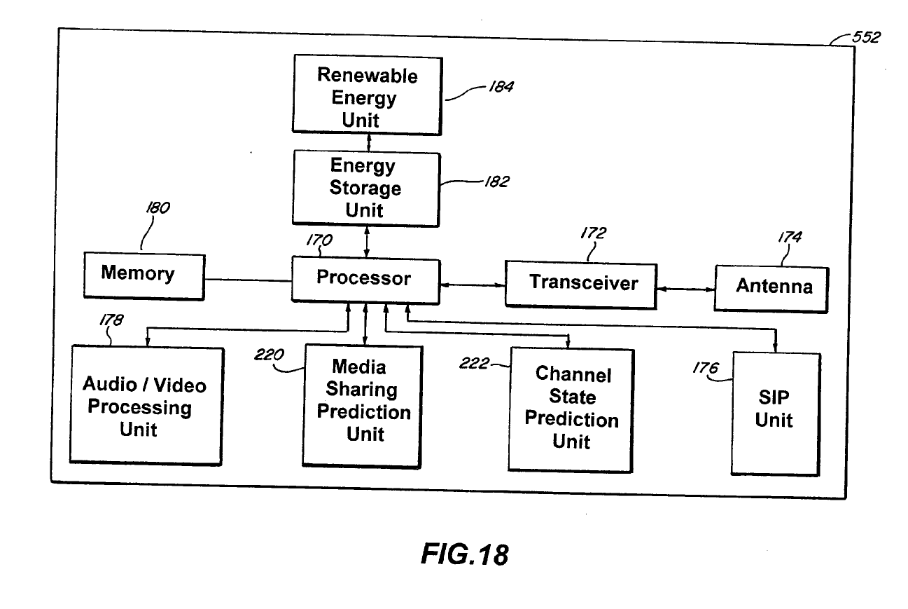

In one embodiment, the present invention can reduce interruptions to video transmissions by predicting channel degradation, and performing media congestion reduction processes. The media congestion reduction processes can be, for example, rate adaptation techniques, such as prioritizing video transmissions and/or degrading video quality accordingly. A node 552 can be used, for example, as shown in FIG. 18. The node 552 is similar to the node 152, except that it includes a media sharing prediction unit 220 and a channel state prediction unit 222. The channel state prediction unit 222 can determine whether there is channel degradation, such as whether the delay time in video transmission will be above a predetermined delay time threshold. The delay in video transmission can be caused, for example, by the SNR being below a predetermined SNR threshold. The media sharing prediction unit 220 can determine whether there is channel degradation from too much media being transmitted at the same time.

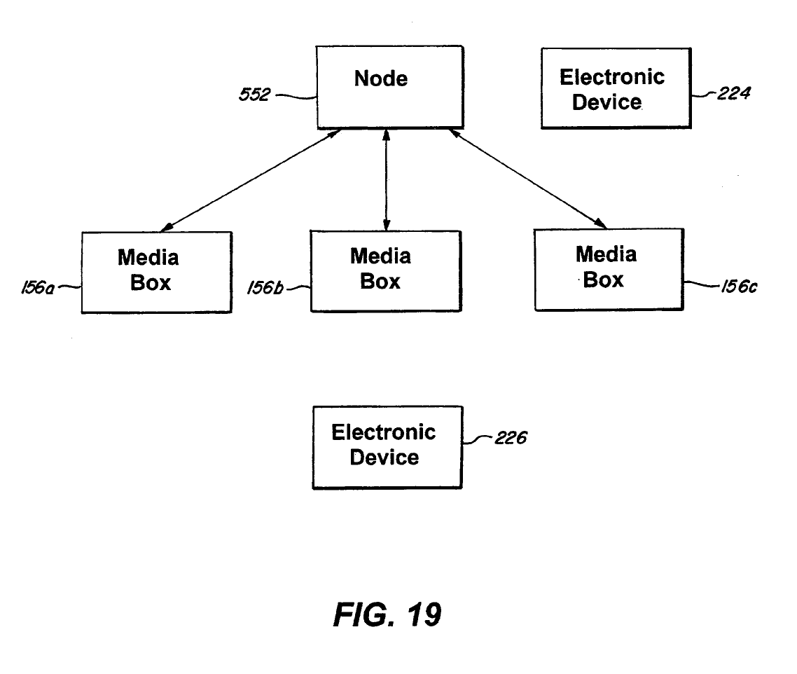

The node 552 in operation can be seen, for example, in a mesh network depicted in FIG. 19. In FIG. 19, the node 552 is wirelessly connected to the media boxes 156a, 156b, and 156c. Near the node 552 and/or the media boxes 156a, 156b, and/or 156c are electronic devices 224 and 225. The electronic devices 224 and 226 could provide interference to the wireless connections for the media boxes 156b and 156c, and the node 552. The interference could cause delays in the video transmissions. The channel state prediction unit 222 can analyze the interference provided by the electronic devices 224 and determine whether the video transmissions will be delayed due to the interference. If the interference would cause a video transmission delay time above an acceptable level for video transmission, the channel state prediction unit 222 can, for example, prioritize video packets and/or indicate to the media boxes 156b and 156c to prioritize video packets. Thus, video packets may be prioritized ahead of, for example, other data packets, and/or voice communication packets. This can ensure that any interruption to video transmissions are minimized since video packets are prioritized ahead of other packets and will be transmitted ahead of other data packets and/or voice communication packets. Thus, while the other data packets and/or voice communication packets may be delayed, video packets will not be delayed or will have any delay minimized. In one embodiment, the media box 156a will not need to prioritize video packets since they will be unaffected by the interference from the electronic device 224. In another embodiment, the channel state prediction unit 222 can proactively indicate to the media boxes 156a to prioritize video packets.

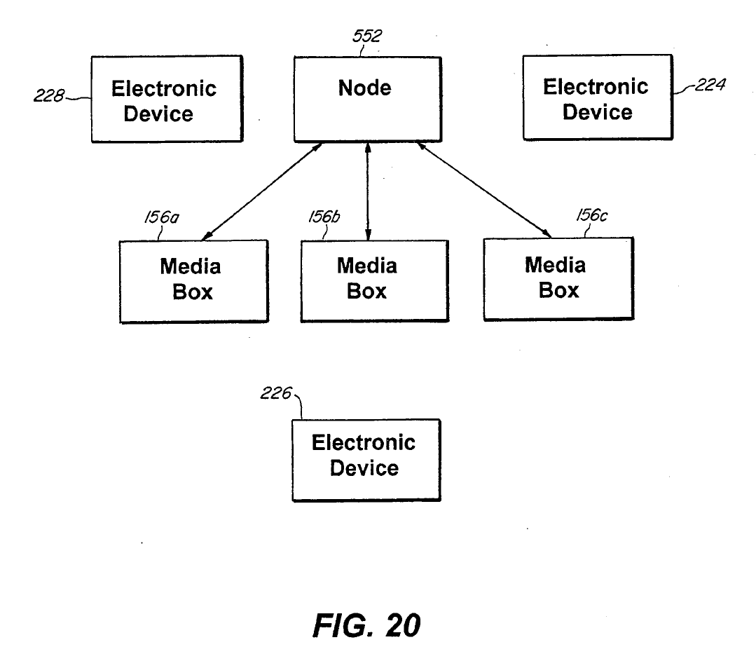

However, when an electronic device 228 appears adjacent the node 552 and the media box 156a, as shown in FIG. 20, the channel state prediction unit 222 can analyze the interference provided by the electronic devices 228 and determine whether the video transmissions to and/or from the media box 156a will be delayed due to the interference. If the interference would cause a video transmission delay time above an acceptable level for video transmission, the channel state prediction unit 222 can, for example, prioritize video packets and/or indicate to the media boxes 156a to prioritize video packets.

In another embodiment, the channel state prediction unit 222, can optionally instruct the audio/video processing unit 178 in the node 552 to degrade the video packets which are transmitted to the media boxes 156a, 156b, and/or 156c. This degradation process can be performed in addition to or instead of instructing the media boxes 156a, al 56b, and/or 156c to prioritize the video packets. For example, the audio/video processing unit 178 can degrade the video packets by removing packets, encoding the video packets at a lower quality, and/or performing any other process which reduces the bandwidth requirements of the video packets. For example, instead of transmitting the video packets in high definition, the video packets can be encoded to be in standard definition. Since the overall video packets, which comprise the video transmission, will have a smaller file size, less bandwidth is required to transmit the video packets. While the video transmission after degradation of the video packets will be lower than prior to the degradation of the video packets, the user can still view the video transmission without interruption or with minimal interruptions.

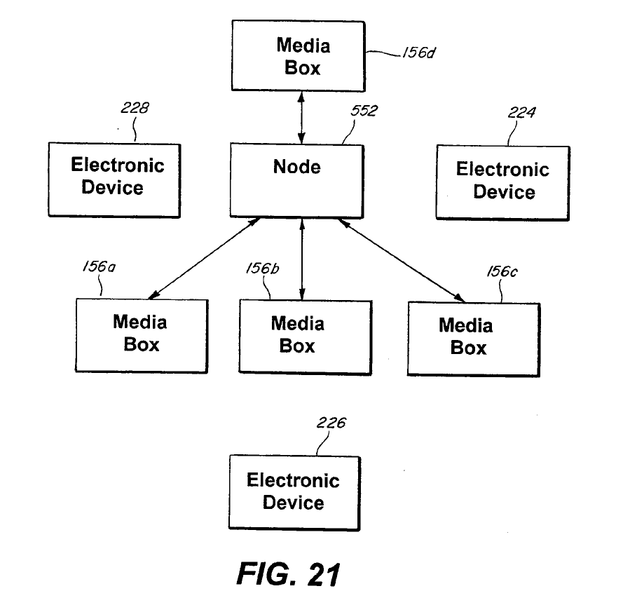

The channel state prediction unit 222 can also analyze additional interferences caused by additional media boxes that connect with the node 552 such as the media box 156d as shown in FIG. 21. Furthermore, the media sharing prediction unit 220 can analyze the additional traffic caused by the connection of the media box 156d. For example, if the media box 156d is also transmitting or receiving video which contributes to delays for video transmissions, then the media sharing prediction unit 222 can, for example, media congestion reduction processes. Thus the media sharing prediction unit 222 can, for example, prioritize video packets, indicate to the media boxes 156a, 156b, and/or 156c to prioritize video packets, degrade the video packets, and/or indicate to the indicate to the media boxes 156a, 156b, and/or 156c to degrade the video packets.

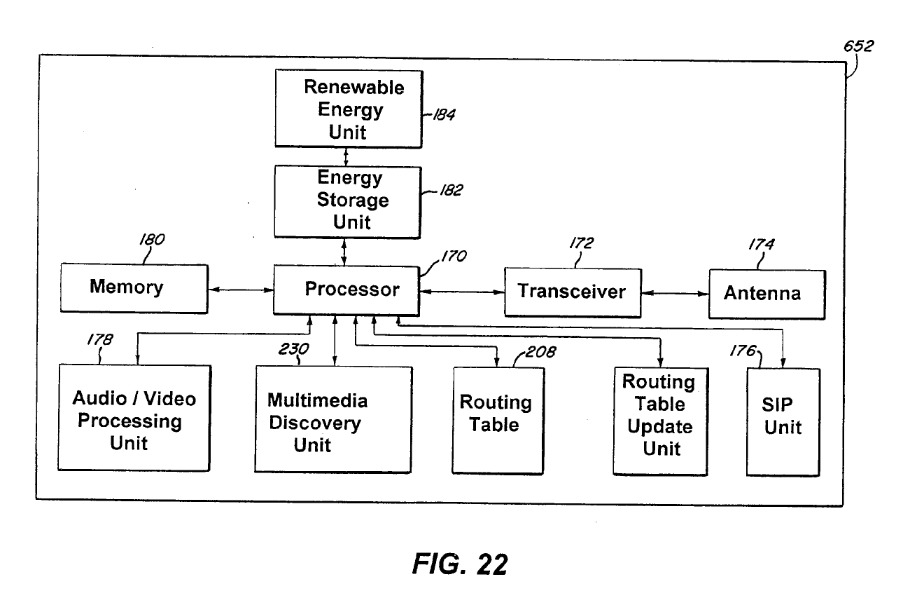

In another embodiment, the present invention can detect multimedia content within a network, such as a mesh network. This can allow users within the mesh network to publish and also to access multimedia content that is not fed to the mesh network from an IP TV source. The present invention can detect, for example, multimedia content that is newly added to the mesh network and allow users of electronic devices connected to the mesh network to view the newly added multimedia content. For example, a node 652 as shown in FIG. 22 can be used. The node 652 is similar to the node 252 except that it further includes a multimedia discovery unit 230. The multimedia discovery unit can discover multimedia content within the mesh network.

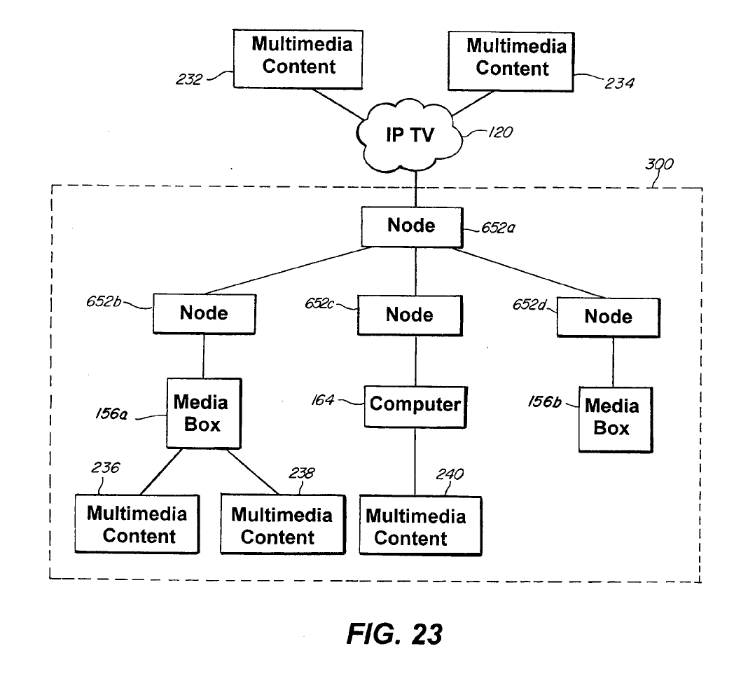

For example, the IP TV 120 can supply multimedia contents 230 and 234 to a mesh network 300, as shown in FIG. 23. Within the mesh network 300, nodes 652a, 652b, 652c, and 652d can supply the multimedia contents 232 and 234 to media boxes 156a and 156b, and a computer 164. Within the mesh network 300, the media box 156 stores and/or publishes the multimedia contents 236 and/or 238, while the computer 164 stores and/or publishes the multimedia content 240. The multimedia discovery unit 230 of the node 652b can notify the other nodes 652a, 652c, and/or 652d of the existence of the multimedia content 236 and/or 238 since the multimedia content 236s and/or 238 is stored and/or published from the media box 156a, which is connected to the node 652b. Thus, the media box 156b and/or the computer 164 can determine the location of and access the multimedia contents 236 and/or 238.

Likewise, the multimedia discovery unit 230 of the node 652c can notify the nodes 652a, 652b, and/or the 652d of the existence of the multimedia content 240. Thus, the media box 156a and/or the media box 156b can determine the location of and access the multimedia content 240. This allows the media box 156a, the media box 156b, and/or the computer 164 to view more multimedia content than just what is distributed by the IP TV 120. In another embodiment, the multimedia discovery units 230 of the nodes 652b, 652c, and/or 652d can inform the node 652a of the existence and/or location of the multimedia contents from devices connected to the nodes 652b, 652c, and/or 652d. The node 652a can then inform the nodes 652b, 652c, and/or 652d of the existence of some or all of the multimedia content within the mesh node 300.

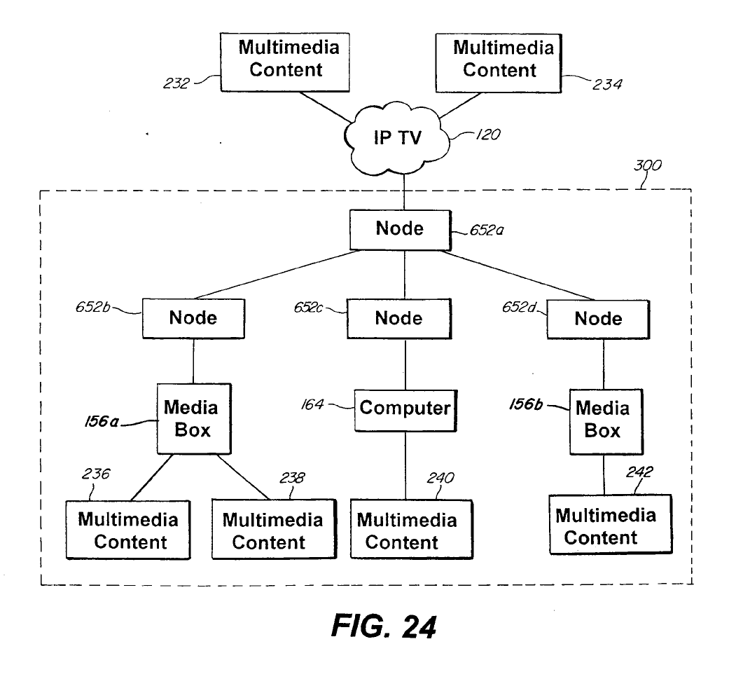

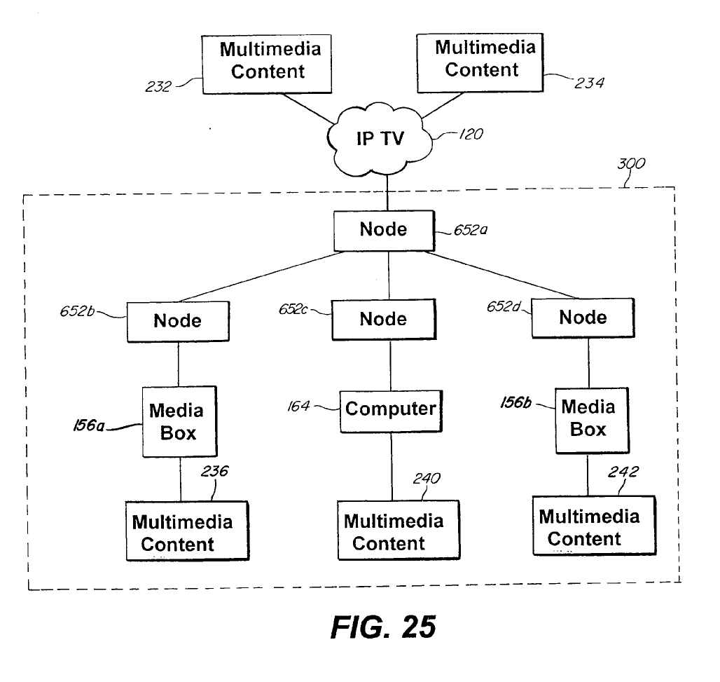

Furthermore, the mesh node 300 can dynamically add and/or delete multimedia content. As seen in FIG. 24, a multimedia content 242 can be added to the mesh node 300 and can be stored, for example, in the media box 156b. The multimedia discovery unit 230 of the node 652d can inform the nodes 652a, 652b, and/or 652c of the existence and location of the multimedia content 242. In addition, the mesh node 300 can also remove multimedia content as seen in FIG. 25. In FIG. 25, the multimedia content 238 is removed from the media box 156a. Since the media box 156a is connected to the node 652b, the node 652b can inform the nodes 652a, 652c, and/or the node 652d that the multimedia content 238 is no longer available. Thus, in the present invention, the multimedia discovery unit 230 can dynamically add or remove additional multimedia content within the mesh network 300. This allows small entities, and/or individual entities to publish content to the mesh network 300. Furthermore, it also allows small entities, and/or individual entities to receive additional multimedia content beyond what is supplied by the IP TV 120. The present invention can therefore, allow an easy and efficient manner for entities, including small entities, to multicast.

Those of ordinary skill would appreciate that the various illustrative logical blocks, modules, and algorithm steps described in connection with the examples disclosed herein may be implemented as electronic hardware, computer software, or combinations of both. Furthermore, the present invention can also be embodied on a machine readable medium causing a processor or computer to perform or execute certain functions.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed apparatus and methods.

The various illustrative logical blocks, units, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A wireless module comprising:
a memory;
a processor connected to the memory;
a session initiation protocol unit connected to the processor; and
a transceiver connected to the processor, the transceiver configured to connect to a wireless local area network in multiple bands.

2. The wireless module of claim 1 further comprising:
an energy storage unit connected to the processor; and
a renewable energy unit connected to the energy storage unit.

3. The wireless module of claim 1 wherein the transceiver is configured to operate in at least two of the 900 MHz band, 2.4 GHz band, 4.9 GHz band, or 5 GHz band.

4. The wireless module of claim 1 wherein the session initiation protocol unit is configured to connect to a mobile phone accessing a phone network through a phone network access unit, the session initiation protocol unit configured to seamlessly maintain access to the phone network for the mobile phone when the mobile phone disconnects from the phone network access unit.

5. The wireless module of claim 1 wherein the transceiver is configured to connect to an electronic device accessing the wireless local area network through a wireless local area network access unit, the transceiver configured to seamlessly maintain access to the wireless local area network for the electronic device when the electronic device disconnects from the wireless local area network access unit.

6. The wireless module of claim 1 further comprising an audio-video processing unit connected to the processor, wherein the transceiver receives and transmits multimedia content and the audio-video processing unit processes the multimedia content.

7. The wireless module of claim 1 further comprising a serial bus port and a high-definition multimedia interface unit, and an Ethernet port.

8. A wireless multimedia system comprising:
a first wireless module including
a first processor,
a first transceiver connected to the first processor and configured to connect to an electronic device and provide the electronic device access to a wireless local area network, and
a first session initiation protocol unit connected to the first processor and configured to connect to a mobile phone and provide the mobile phone access to a phone network using a session initiated protocol; and
a second wireless module including
a second processor,
a second transceiver connected to the second processor and configured to connect to the electronic device and seamlessly maintain access to the wireless local area network for the electronic device when the electronic device terminates connection with the first wireless module, and
a second session initiation protocol unit configured to connect to the mobile phone and seamlessly maintain access to the phone network for the mobile phone when the mobile phone terminates connection with the first wireless module.

9. The system of claim 8 wherein the first wireless module and the second wireless module are in a mesh network.

10. The system of claim 8 wherein the first wireless module and the second wireless module are configured to operate in multiple bands.

11. The system of claim 8 wherein the first wireless module and the second wireless module are configured to operate in at least two of the 900 MHz band, 2.4 GHz band, 4.9 GHz band, or 5 GHz band.

12. The system of claim 8 wherein the second wireless module includes an audio-video processing unit.

13. The system of claim 8 wherein the first wireless module includes
an energy storage unit connected to the processor, and
a renewable energy unit connected to the energy storage unit.

14. The system of claim 8 further comprising
a first earth station antenna connected to the first wireless module;
a second earth station antenna configured to communicate with the first earth station antenna; and
a multimedia unit connected to the second earth station antenna and configured to access multimedia content, wherein the multimedia unit transmits the multimedia content to the first wireless module.

15. The system of claim 14 wherein the multimedia content includes content from the Internet or broadcast data.

16. The system of claim 15 wherein the multimedia unit adds proprietary content to the multimedia content and transmits the multimedia content with the proprietary content to the first wireless module.

17. The system of claim 8 wherein the first wireless module transmits data to the second wireless module using a one plus one (1+1) ring protection mode.

18. A method for providing multimedia content and phone connectivity comprising:
providing multimedia content to a first wireless module;
providing an electronic device access to a wireless local area network using the first wireless module;
providing the electronic device access to the wireless local area network using a second wireless module;
seamlessly maintaining access to the wireless local area network for the electronic device when the electronic device terminates connection with the first wireless module;
providing a mobile phone access to a phone network using the first wireless module;
providing the mobile phone access to the phone network using the second wireless module; and
seamlessly maintaining access to the phone network for the mobile phone when the mobile phone terminates connection with the first wireless module.

19. The method of claim 18 further comprising operating the first wireless module in at least two of the 900 MHz band, 2.4 GHz band, 4.9 GHz band, or 5 GHz band.

20. The method of claim 19 further comprising adding proprietary content to the multimedia content.

21. A wireless module comprising:
a processor;
a session initiation protocol unit connected to the process and configured to connect to a mobile phone and provide the mobile phone access to a phone network using a session initiated protocol; and
a signal analysis unit connected to the processor and configured to analyze a phone connectivity quality for the phone network, the signal analysis unit performing a seamless handoff of the mobile phone to a cellular tower when the phone connectivity for the phone network is below a predetermined phone connectivity quality threshold.

22. A wireless network system comprising:
a first node located on an exterior of a building and connected to a network;
a switch connected to the network through the first node, the switch located on an interior of the building; and
a second node connected to the network through the switch, the second node located on the interior of the building.

23. A wireless module comprising:
a processor;
a transceiver connected to the processor and configured to wirelessly connect to an electronic device;
a memory connected to the processor and storing a routing table indicating a location of the electronic device; and
a routing table update unit connected to the memory, the routing table update unit proactively determining a location of the electronic device and updating the routing table to indicate the location of the electronic device.

24. A wireless module comprising:
a processor;
a transceiver connected to the processor and configured to wirelessly connect to other wireless modules; and
a link analysis unit connected to the processor, the link analysis unit determining path delay information for paths between the wireless module and the other wireless modules.

25. A wireless module comprising:
a processor;
a transceiver connected to the processor and configured to wirelessly connect to other wireless modules and receive path delay information for paths between the other wireless modules; and
a route flow manager connected to the processor and analyzing the path delay information to determine whether paths between the other wireless modules should be altered.

26. A wireless module comprising:
a processor;
a transceiver connected to the processor and configured to wirelessly connect to electronic devices and a network; and
a media sharing prediction unit configured to analyze media traffic in the network and perform a media congestion reduction process.

27. A wireless module comprising:
a processor;
a transceiver connected to the processor and configured to wirelessly connect to electronic devices and a network; and
a channel state prediction unit configured to analyze interference in the network and perform a media congestion reduction process.

28. A wireless module comprising:
a processor;
a transceiver connected to the processor and configured to wirelessly connect to a network; and
a multimedia discovery unit configured to determine a location of multimedia content in the network.
